(19) United States
(12) Patent Application Publication
(10) Pub. No.: US 2023/0199746 A1
(43) Pub. Date: Jun. 22, 2023

(54) METHODS AND DEVICES FOR A SEMANTIC COMMUNICATION FRAMEWORK

(71) Applicant: Intel Corporation, Santa Clara, CA (US)

(72) Inventors: Rath VANNITHAMBY, Portland, OR (US); Kathiravetpillai SIVANESAN, Portland, OR (US); Vallabhajosyula SOMAYAZULU, Portland, OR (US); Shilpa TALWAR, Cupertino, CA (US)

(21) Appl. No.: 17/555,559

(22) Filed: Dec. 20, 2021

(51) Int. Cl. H04W 72/12; H04W 28/02; H04W 4/70; G06N 20/00

(52) U.S. Cl. CPC H04W 72/1205; H04W 28/0268; H04W 4/70; G06N 20/00; H04W 80/12

(57) ABSTRACT

A device may include a processor configured to extract semantic information from received data, generate one or more data elements based on the extracted semantic information for an instance of time, generate metadata associated with the generated one or more data elements, schedule a transmission of the one or more data elements and the metadata according to a scheduling configuration, and encode scheduling information indicating the scheduling configuration for the transmission.

### TECHNICAL FIELD

This disclosure generally relates to methods and devices for a semantic communication framework.

### BACKGROUND

Traditional communication techniques may involve reproducing at a receiving entity either exactly or approximately the same information that a transmitting entity may transmit. In various examples, the receiving entity may not need to obtain the whole data and the receiving entity may rely on the semantic aspects that the transmitting entity may transmit in order to receive and process data, especially depending on the configuration of the received information at the receiving entity. For the purpose of conveying meaningful information to the receiving entity, the transmitting entity may transmit data using various formats, models, or communication channels.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary internal configuration of a communication device;

FIG. 2 shows an example of a communication device;

FIG. 3 shows an example of a processor of a communication device;

FIG. 4 exemplarily shows an illustration with respect to priority and protection levels;

FIG. 5 shows an example of a processor of a communication device;

FIG. 6 shows an example of an AWL;

FIG. 7 shows another example of an AWL;

FIG. 8 shows another example of an AWL;

FIG. 9 shows an illustration with respect to AI/ML module;

FIG. 10 shows an example of a method;

FIG. 11 shows an example of a communication device;

FIG. 12 shows an example of a processor of a communication device;

FIG. 13 shows an example of an AWL;

FIG. 14 shows an example of an AWL;

FIG. 15 shows an illustration with respect to communication devices;

FIG. 16 shows an example of a communication system;

FIG. 17 shows an example of a method;

FIG. 18 shows an illustration of an AI/ML model including a neural network;

FIG. 19 shows an example of a communication system;

FIG. 20 shows an example of a communication system;

FIG. 21 shows an illustration with respect to a communication device;

FIG. 22 shows an example of a method;

FIG. 23 exemplarily shows an illustration of a communication system.

### DESCRIPTION

The following detailed description refers to the accompanying drawings that show, by way of illustration, exemplary details and aspects in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

The term “sensor” refers to any type of devices suitable for sensing or monitoring and providing information that is representative of or characteristic for a domain of the application.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies), and may use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, the apparatuses and methods described herein can also employ radio communication technologies on a secondary basis on bands such as the TV White Space bands (typically below 790 MHz) where e.g. the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e. unidirectional or bidirectional communication in one or both of the incoming and outgoing directions. The term “calculate” encompass both ‘direct’ calculations via a mathematical expression/formula/relationship and ‘indirect’ calculations via lookup or hash tables and other array indexing or searching operations. The term “channel state information” is used herein to refer generally to the wireless channel for a wireless transmission between one or more transmitting antennas and one or more receiving antennas and may take into account any factors that affect a wireless transmission such as, but not limited to, path loss, interference, and/or blockage.

An antenna port may be understood as a logical concept representing a specific channel or associated with a specific channel. An antenna port may be understood as a logical structure associated with a respective channel (e.g., a respective channel between a user equipment and a base station). Illustratively, symbols (e.g., OFDM symbols) transmitted over an antenna port (e.g., over a first channel) may be subject to different propagation conditions with respect to other symbols transmitted over another antenna port (e.g., over a second channel).

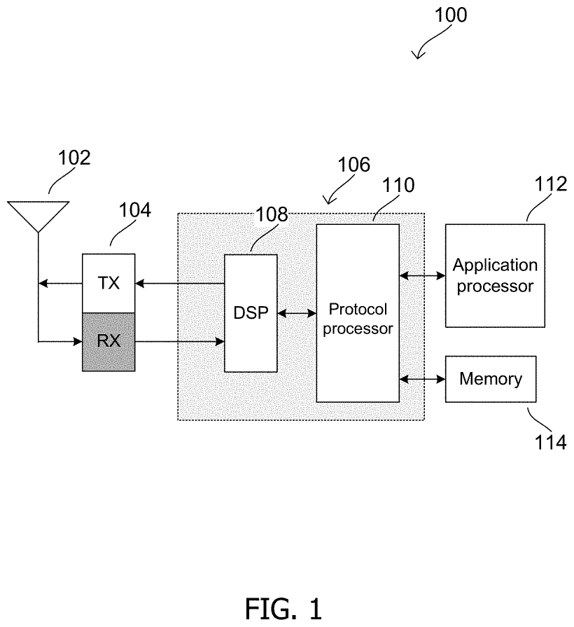

FIG. 1 shows an exemplary internal configuration of a communication device. The communication device may include a terminal device, a receiving entity or a transmitting entity and it will be referred to as communication device, but the communication device 100 may also include various aspects of network access nodes as well. The communication device 100 may include antenna system 102, radio frequency (RF) transceiver 104, baseband modem 106 (including digital signal processor 108 and protocol controller 110), application processor 112, and memory 114. Although not explicitly shown in FIG. 1, in some aspects communication device 100 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 100 may transmit and receive radio signals on one or more radio access networks. Baseband modem 106 may direct such communication functionality of communication device 100 according to the communication protocols associated with each radio access network, and may execute control over antenna system 102 and RF transceiver 104 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of communication device 100 shown in FIG. 1 depicts only a single instance of such components.

Communication device 100 may transmit and receive wireless signals with antenna system 102. Antenna system 102 may be a single antenna or may include one or more antenna arrays that each include multiple antenna elements. For example, antenna system 102 may include an antenna array at the top of communication device 100 and a second antenna array at the bottom of communication device 100. In some aspects, antenna system 102 may additionally include analog antenna combination and/or beamforming circuitry. In the receive (RX) path, RF transceiver 104 may receive analog radio frequency signals from antenna system 102 and perform analog and digital RF front-end processing on the analog radio frequency signals to produce digital baseband samples (e.g., In-Phase/Quadrature (IQ) samples) to provide to baseband modem 106. RF transceiver 104 may include analog and digital reception components including amplifiers (e.g., Low Noise Amplifiers (LNAs)), filters, RF demodulators (e.g., RF IQ demodulators)), and analog-to-digital converters (ADCs), which RF transceiver 104 may utilize to convert the received radio frequency signals to digital baseband samples. In the transmit (TX) path, RF transceiver 104 may receive digital baseband samples from baseband modem 106 and perform analog and digital RF front-end processing on the digital baseband samples to produce analog radio frequency signals to provide to antenna system 102 for wireless transmission. RF transceiver 104 may thus include analog and digital transmission components including amplifiers (e.g., Power Amplifiers (PAs), filters, RF modulators (e.g., RF IQ modulators), and digital-to-analog converters (DACs), which RF transceiver 104 may utilize to mix the digital baseband samples received from baseband modem 106 and produce the analog radio frequency signals for wireless transmission by antenna system 102. In some aspects baseband modem 106 may control the radio transmission and reception of RF transceiver 104, including specifying the transmit and receive radio frequencies for operation of RF transceiver 104.

As shown in FIG. 1, baseband modem 106 may include digital signal processor 108, which may perform physical layer (PHY, Layer 1) transmission and reception processing to, in the transmit path, prepare outgoing transmit data provided by protocol controller 110 for transmission via RF transceiver 104, and, in the receive path, prepare incoming received data provided by RF transceiver 104 for processing by protocol controller 110. Digital signal processor 108 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 108 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 108 may include one or more processors configured to retrieve and execute program code that defines control and processing logic for physical layer processing operations. In some aspects, digital signal processor 108 may execute processing functions with software via the execution of executable instructions. In some aspects, digital signal processor 108 may include one or more dedicated hardware circuits (e.g., ASICs, FPGAs, and other hardware) that are digitally configured to specific execute processing functions, where the one or more processors of digital signal processor 108 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 108 may be realized as a coupled integrated circuit.

Communication device 100 may be configured to operate according to one or more radio communication technologies. Digital signal processor 108 may be responsible for lower-layer processing functions (e.g., Layer 1/PHY) of the radio communication technologies, while protocol controller 110 may be responsible for upper-layer protocol stack functions (e.g., Data Link Layer/Layer 1 and/or Network Layer/Layer 3). Protocol controller 110 may thus be responsible for controlling the radio communication components of communication device 100 (antenna system 102, RF transceiver 104, and digital signal processor 108) in accordance with the communication protocols of each supported radio communication technology, and accordingly may represent the Access Stratum and Non-Access Stratum (NAS) (also encompassing Layer 1 and Layer 3) of each supported radio communication technology. Protocol controller 110 may be structurally embodied as a protocol processor configured to execute protocol stack software (retrieved from a controller memory) and subsequently control the radio communication components of communication device 100 to transmit and receive communication signals in accordance with the corresponding protocol stack control logic defined in the protocol software. Protocol controller 110 may include one or more processors configured to retrieve and execute program code that defines the upper-layer protocol stack logic for one or more radio communication technologies, which can include Data Link Layer/Layer 1 and Network Layer/Layer 3 functions. Protocol controller 110 may be configured to perform both user-plane and control-plane functions to facilitate the transfer of application layer data to and from radio communication device 100 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 110 may include executable instructions that define the logic of such functions.

Communication device 100 may also include application processor 112 and memory 114. Application processor 112 may be a CPU, and may be configured to handle the layers above the protocol stack, including the transport and application layers. Application processor 112 may be configured to execute various applications and/or programs of communication device 100 at an application layer of communication device 100, such as an operating system (OS), a user interface (UI) for supporting user interaction with communication device 100, and/or various user applications. The application processor may interface with baseband modem 106 and act as a source (in the transmit path) and a sink (in the receive path) for user data, such as voice data, audio/video/image data, messaging data, application data, basic Internet/web access data, etc. In the transmit path, protocol controller 110 may therefore receive and process outgoing data provided by application processor 112 according to the layer-specific functions of the protocol stack, and provide the resulting data to digital signal processor 108. Digital signal processor 108 may then perform physical layer processing on the received data to produce digital baseband samples, which digital signal processor may provide to RF transceiver 104. RF transceiver 104 may then process the digital baseband samples to convert the digital baseband samples to analog RF signals, which RF transceiver 104 may wirelessly transmit via antenna system 102. In the receive path, RF transceiver 104 may receive analog RF signals from antenna system 102 and process the analog RF signals to obtain digital baseband samples. RF transceiver 104 may provide the digital baseband samples to digital signal processor 108, which may perform physical layer processing on the digital baseband samples. Digital signal processor 108 may then provide the resulting data to protocol controller 110, which may process the resulting data according to the layer-specific functions of the protocol stack and provide the resulting incoming data to application processor 112. Application processor 112 may then handle the incoming data at the application layer, which can include execution of one or more application programs with the data and/or presentation of the data to a user via a user interface.

Memory 114 may embody a memory component of communication device 100, such as a hard drive or another such permanent memory device. Although not explicitly depicted in FIG. 1, the various other components of communication device 100 shown in FIG. 1 may additionally each include integrated permanent and non-permanent memory components, such as for storing software program code, buffering data, etc.

In accordance with some radio communication networks, communication device 102 may execute mobility procedures to connect to, disconnect from, and switch between available network access nodes of the radio access network of radio communication network. As each network access node of radio communication network may have a specific coverage area, communication devices 102 may be configured to select and re-select \ available network access nodes in order to maintain a strong radio access connection with the radio access network of radio communication network. For example, communication device 100 may establish a radio access connection with network access node 110 or communication device 100 may communicate with another communication device using radio communication.

In many communication systems, especially with respect to communicating data obtained by sensing devices that may detect events or changes in the environment (i.e. sensors, such as cameras, microphones, etc.), the transmitted data may include raw data including any type of information that the sensors may capture (e.g. images or video images for cameras) with an intention to convey any type of information that the sensors may have captured. In various scenarios, it may be desirable to convey only the information that may be meaningful for the receiving entity in order to reduce the amount of data for transmissions.

With the involvement of internet of things IoT technology, various types of sensors may be employed at various locations resulting in allocation for resources in terms of the available bandwidth. However, many use cases may not need the raw data that such sensors may obtain, and it may be desirable for certain use cases to convey only meaningful information, such as semantics or semantic information to the receiving entities.

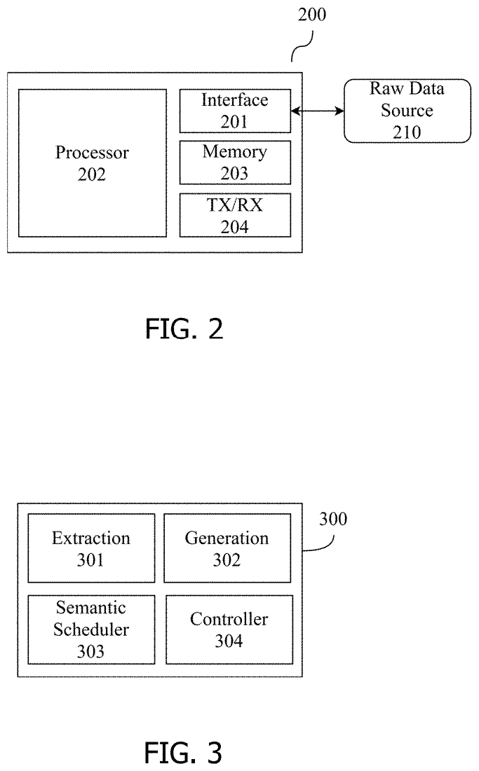

FIG. 2 shows an example of a communication device according to various aspects of this disclosure. The communication device 200 may include a computing device of any type that may process data and transmit communication signals as provided in this disclosure. For example, the communication device 200 may include a terminal device, a computer e.g. a desktop computer or a tablet computer, a mobile device, a mobile communication device e.g. a mobile terminal or a smartphone, a wearable device e.g. a smart watch or a smart googles, a device for a smart home (domotics), an internet of things (IoT) device, a vehicle computer e.g. an autonomous vehicle or an automated and/or assisted driving vehicle. The communication device 200 may include components that may include hardware components and/or software components. In various examples, the communication device may be deemed as a transmitting entity.

The communication device 200 may include an interface 201 to receive raw data from a raw data source 210. For example, the raw data source 210 may include a sensor and the interface 201 may be couplable to the sensor to receive information with respect to detection and monitoring operations of the sensor. Accordingly, the raw data may include information with respect to various detection activities of the sensor. When the sensor includes a camera, the raw data may include video images that the sensor may provide. The nature of the raw data may vary depending on the application, especially in terms of the information that was provided with the raw data. In any event, the raw data may refer to any type of data that a processor (or any type of processing means) may extract semantic information with respect to at least one feature by processing. In various examples, the communication device 200 may include the sensor that provides the received raw data.

The communication device 200 may include a memory 203 to perform various operations as provided in this disclosure. In various examples, the memory 203 may store the received raw data, and the processor 202 may process the received raw data by accessing the received raw data in the memory 203. In various examples, the received raw data may include a data that the processor 202 may have obtained by performing various processing functions on a data stored in the memory 203.

The communication device 200 may include a processor 202. The processor 202 may include one or more processors or processing units that are configured to perform various functions. For example, the processor 202 may include a central processing unit, a graphics processing unit, a hardware acceleration unit, a neuromorphic chip, and/or a controller. The processor 202 may be implemented in one processing unit, e.g. a system on chip (SOC), or a processor. The processor 202 is exemplified herein as it includes various units that are directed to various functions for efficient processing.

The processor 202 may extract semantic information from the received raw data. The processor 202 may use any known techniques to extract the semantic information from the received raw data. For example, the processor 202 may identify one or more portions of the received raw data that the processor 202 may distinguish based on predefined extraction parameters. The processor 202 may process the received raw data by using various transformation techniques, such as Fourier transform or wavelet transform. Furthermore, the processor 202 may compare various physical features with respect to the received raw data based on the predefined extraction parameters, such as amplitude, frequency, or phase, apply thresholding methods, and/or perform mathematical operations to identify the one or more portions that the processor 202 may distinguish. The processor 202 may compare various physical features with another received raw data obtained with respect to another instance of time. The another instance of time may be before or after the instance of time with respect to the received raw data.

The processor 202 may extract the semantic information from the received raw data based on the extracted features. The semantic information may include information representing one or more attributes detected from the received raw data. The processor 202 may extract the semantic information from the received data according to predefined extraction parameters designated to obtain information with respect to various attributes from a received data. Furthermore, the processor 202 may extract at least a portion of metadata from the received raw data. The metadata may include syntactic information with respect to the received raw data. The metadata may further include structural information with respect to the received raw data. The metadata may further include syntactic information or structural information with respect to the received raw data.

The processor 202 may further generate one or more data elements based on the extracted semantic information from the received raw data. The processor 202 may further generate metadata associated with the one or more data elements. In various examples, the processor 202 may generate the metadata based on the received raw data and based on the extracted semantic information.

Once the processor 202 generates the metadata and the one or more elements with respect to the received raw data, the processor 202 may schedule a transmission of the one or more data elements and the metadata according to a scheduling configuration. It may be desirable to transmit the one or more elements and the metadata by scheduling different transmissions to a receiving entity as the metadata and the one or more elements generated with respect to the extracted semantic information. In various examples, one may be scheduled before the other with an intention to reduce overhead and handle the network conditions by prioritizing the transmission of the critical data.

Furthermore, it may be desirable to schedule transmissions of the one or more data elements, and the metadata including information that is related to the one or more data elements with different frequencies. For example, the transmission of the one or more data elements may be expected more frequently, and the information that the metadata may include may change in a less frequent manner than the information that the one or more data elements may convey to the receiving entity.

Furthermore, the processor 202 may encode scheduling information indicating the scheduling configuration for the transmission of the one or more data elements and the metadata with an intention to provide an indication to the receiving entity to provide a kind of mapping with respect to the extracted semantic information from the received raw data for an instance of time according to the one or more data elements and the metadata.

The communication device 200 may further include a communication interface including at least one transmitting circuit 204. The communication circuit may include a receiving circuit 204 as well, and in this case, the transmitting and the receiving circuit 204 may be referred to as TX/RX circuit 204. The communication interface may support communication via various communication technologies. For example, the communication interface (e.g. TX/RX circuit 204) may include components that are configured to perform radio communication technologies, as provided exemplarily with respect to FIG. 1. Accordingly, the communication interface may include one or more radio communication circuits to communicate according to one or more radio communication technologies. Furthermore, the communication interface may include components that are configured to perform wired communication technologies, e.g. a circuitry configured to perform communication according to Universal Serial Bus (USB) protocol, a circuitry for Universal Asynchronous Receiver/Transmitter (UART) communication, a circuitry for RS-232 communication, etc.

FIG. 3 shows an example of a processor of a communication device 200 according to various aspects provided in this disclosure. The processor 300 is depicted to include various functional modules that are configured to provide various functions respectively. The skilled person would recognize that the depicted functional modules are provided to explain various operations that the processor 300 may be configured to.

The processor 300 may include an extraction module 301 that is configured to extract the semantic information from received raw data. The extraction module 301 may use any known techniques to extract the semantic information from the received raw data. The extraction module 301 may operate based on extraction parameters that may be predefined according to the structure of the received raw data, the type of information that the received raw data may include, features that the received raw data may provide, possible attributes that the received raw data may provide an indication of, and such. The extraction parameters may define a specific model or ontology in a manner that the extraction module 301 may extract the semantic information with respect to the model. Accordingly, the extraction parameters providing the model may be predefined according to the type of the application and the information that is designated for transmission.

For example, in a constellation that the received raw data may include an image or a plurality of images, the extraction module 301 may be configured to perform image processing methods to identify one or more objects in the image or the plurality of images and provide one or more attributes with respect to the identified one or more objects in the image or the plurality of images. The provided attributes may also vary depending on the configuration of the extraction module 301. The attribute may include only an indication of the existence of the object in the image or the plurality of images. The attributes may further include more information with respect to the detected object, such as position, size, movement, velocity, etc. The provided attributes may relate to the content of the received raw data for an instance of time. The instance of time may include an instant of time, or a plurality of instants of time, or a period of time.

In another constellation that the received raw data may include audio signals or audio data with respect to a speech, the extraction module 301 may perform audio processing methods to identify a voice in the audio signals or the audio data and provide one or more attributes with respect to the identified voice or voices in the audio signals or the audio data. The attributed attributes may similarly vary depending on the configuration of the extraction module 301. The attribute may include only an indication of the existence of the voice. The attributes may further include more information with respect to the detected voice, such as the words identified with respect to the detected voice.

The extraction module 301 may include various algorithms to extract various types of the semantic information from the received raw data. As indicated before, the extraction module 301 may pre-process the raw data using various transformation techniques, such as Fourier Transform or Wavelet Transform functions. The extraction module 301 may perform various signal processing techniques depending on the predefined extraction techniques to extract the semantic information from the received raw data.

Furthermore, the extraction module 301 may obtain information to generate the metadata. The extraction module 301 may analyze the received raw data to obtain syntactic information and structural information with respect to the received raw data. Syntactic information may include non-contextual information with respect to the received raw data and its content. For example, the syntactic information may include the instance of time that the received raw data relates to, such as generation time of the received raw data, a period of time with respect to the content of the received raw data (e.g. detection time), an identifier with respect to the received raw data or the source of the received raw data, etc. Structural information may include information regarding the structure of the received raw data, especially in terms of how the received raw data is structured.

Furthermore, the extraction module 301 may obtain further contextual information with respect to the received raw data to a certain extent. The further contextual information may relate to the content of the received raw data, and in various examples to the content of the extracted semantic information. The further contextual information may provide information with respect to environmental details of the content, such as weather condition, lighting, color of the objects (e.g. for image or images), or various detections that may provide a context with respect to the extracted semantic information, such as a detected emotion, words per minute, pauses (e.g. for audio). While the extracted semantic information may add relationships with respect to the metadata by providing descriptions with respect to the content of the received raw data as attributes based on the extraction model, and capture the meaning associated with the content of the received raw data.

The processor 300 may further include a generation module 302. Once the extraction module 301 extracts the semantic information, and information with respect to the metadata, the generation module 302 may generate data elements based on the extracted information. In various examples, for each extracted semantic information element (e.g. each piece of information indicating one attribute in the content of the received raw data) the generation module 302 may generate one or more data elements. The generation module 302 may operate collectively with a semantic scheduler 303 to generate the data elements as provided in this disclosure.

The processor 300 may further include the semantic scheduler 303. The semantic scheduler 303 schedule the one or more data elements based on various aspects provided in this disclosure. The semantic scheduler 303 may determine different transmission priorities with respect to the metadata and the one or more data elements. The semantic scheduler 303 may determine different transmission priorities with respect to at least a portion of the one or more data elements over other portion of the one or more data elements. In various examples, the communication device 200 may also transmit the received raw data, and the semantic scheduler 303 may also determine different transmission priorities with respect to the metadata, the one or more data elements, and the received raw data. The semantic scheduler 303 may determine transmission priorities with respect to a predefined configuration.

Furthermore, the semantic scheduler 303 may determine various encoding configurations with respect to the metadata and the one or more data elements. The semantic scheduler 303 may determine various encoding configurations with respect to at least a portion of the one or more data elements over other portion of the one or more data elements. In various examples, the communication device 200 may also transmit the received raw data, and the semantic scheduler 303 may also determine various encoding configurations for the metadata, the one or more data elements, and the received raw data. The semantic scheduler 303 may determine an encoding configuration for the data to be transmitted based on a predefined configuration.

The semantic scheduler 303 may selectively apply various encoding configurations for each of the one or more data elements generated with respect to the extracted semantic information based on the extracted semantic information. In various scenarios, the extracted semantic information may include information with respect to a plurality of attributes, and some of the attributes may be more critical than others. For example, in a use case with respect to a vehicle detection, the attribute in the extracted semantic information indicating the location of the vehicle may be more critical than the size (e.g. the bounding box) of the vehicle. Accordingly, it may be desirable to encode the one or more data elements including information indicating the location of the vehicle with a configuration to provide more protection for transmitting the respective data elements.

The semantic scheduler 303 may determine the encoding configuration based on a predefined configuration scheme, for example indicating different configurations for different attributes. Based on the attribute (or a type of attribute) with respect to the extracted semantic information for one or more data elements, the semantic scheduler 303 may determine a modulation and coding scheme (MCS) and/or transmit power to be used for transmission of the one or more data elements according to the respective encoding configuration. Accordingly, the semantic scheduler 303 may selectively apply different encoding configurations for different attributes or attribute types.

Furthermore, the semantic scheduler 303 may determine different encoding configurations with respect to the metadata and the one or more data elements as well. Accordingly, the semantic scheduler 303 may select a first encoding configuration for transmission of the metadata, and select a second (or more) encoding configuration for transmission of the one or more data elements.

Furthermore, as indicated before, the communication device may transmit the metadata and the one or more data elements at different periodicities. The semantic scheduler 303 may selectively schedule the transmission of the metadata, and the semantic scheduler 303 may determine not to transmit the metadata on various occasions. For example, the semantic scheduler 303 may schedule the transmission of the metadata and the one or more data elements independently from each other. The semantic scheduler 303 may receive an indication with respect to the quality of a communication channel between the communication device 200 and a receiving entity (e.g. a network quality parameter), and the semantic scheduler 303 may schedule transmission of the metadata and the one or more elements associated with the metadata independently from each other based on the network quality parameter.

Furthermore, the semantic scheduler 303 may schedule the transmission of the one or more elements in a continuous manner, and the semantic scheduler 303 may schedule the transmission of the metadata in predetermined intervals. When the network quality parameter indicates that the network quality is below a predetermined threshold, the semantic scheduler 303 may schedule the transmission of the metadata by reducing the periodicity (i.e. by increasing the period of time of the intervals) to transmit the metadata.

The semantic scheduler 303 may schedule the transmission of the one or more elements with respect to the content of the received raw data more frequently than the transmission of the metadata. Furthermore, the semantic scheduler 303 may prioritize the transmission of the one or more data elements relative to the transmission of the metadata in some examples based on the network quality parameter.

As indicated, the communication device may also transmit the received raw data on various occasions. The semantic scheduler 303 may determine a different encoding configuration with respect to the transmission of the received raw data, and the semantic scheduler 303 may determine a different scheduling priority for the transmission of the received raw data, in a manner that the encoding configuration and/or the scheduling priority may be different from at least one of the encoding configuration and/or the scheduling priority of the one or more data elements respectively. The semantic scheduler 303 may determine a different scheduling priority for the transmission of the received raw data, in a manner that the encoding configuration and/or the scheduling priority may be different from at least one of the encoding configuration and/or the scheduling priority of the metadata respectively.

The semantic scheduler 303 may schedule the transmission of the one or more elements and the transmission of the received raw data in a selective manner. In other words, the semantic scheduler 303 may either schedule the transmission of the one or more elements with respect to the received raw data, or the transmission of the received raw data for an instance of time that the one or more elements relate to the content of the received raw data. The semantic scheduler 303 may selectively schedule the transmission of the one or more elements with respect to the received raw data or the received raw data based on the network quality parameter, in a manner, if the network quality parameter indicates that the communication channel may allow the transmission of the received raw data, the semantic scheduler 303 may schedule the transmission of the received raw data.

In various examples, the semantic scheduler 303 may determine a protection level and/or a priority level for each information with respect to the received raw (i.e. the one or more data elements, metadata, and received raw data) data to be transmitted. The semantic scheduler 303 may determine a protection level and/or priority level for each information based on predefined configurations indicating a mapping operation between each information and the respective priority and/or protection level. In various examples, the semantic scheduler 303 may determine only one level that may indicate both the protection level and the priority level.

Furthermore, the semantic scheduler 303 may provide information indicating the scheduling configuration for the transmission of the information with respect to the received raw data (e.g. the one or more data elements, the metadata, and the received raw data), especially in terms of identifying the information that is scheduled for transmissions with respect to the received raw data.

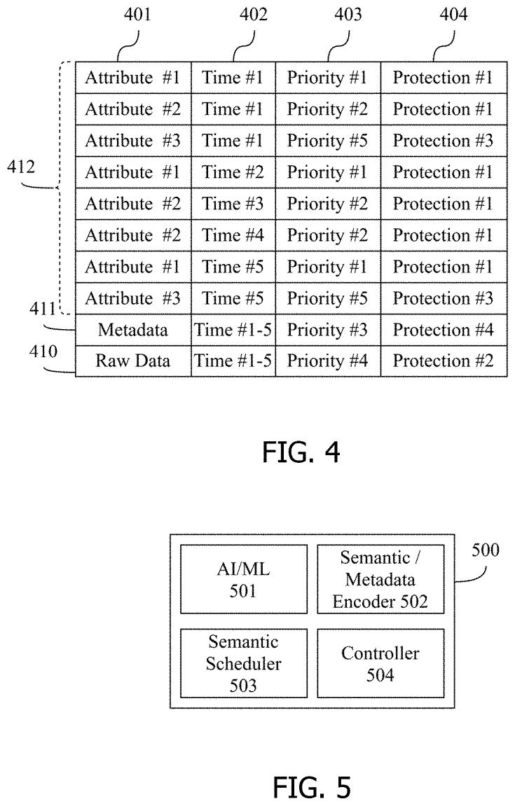

FIG. 4 exemplarily shows an illustration with respect to priority and protection levels. The first column 401 indicates the type of information, and attribute #x denoting the type of the respective attribute, the second column 402 indicates time information that the information relates to, the third column 403 indicates a determined priority level for the information, and the fourth column 404 indicates the protection level for the information.

For a received raw data 410, an extraction module may extract the semantic information and information related to the metadata 411. A generation module may generate the one or more data elements 412 indicating a plurality of attributes with respect to the content of the received raw data with respect to instances of time 1-5 for various instances of time. The generation module may also generate the metadata 411 as provided for this disclosure.

Based on the extracted semantic data indicating various attributes for various attribute types, a semantic scheduler (e.g. the semantic scheduler 303) may determine various priority levels and protection levels based on attribute types. For this illustrative example, the Attribute #1 is considered to have the most importance, and accordingly the semantic scheduler determines the highest possible priority and protection levels for the Attribute #1 for all instances of time. The Attribute #3 is considered to have the least importance in terms of scheduling priority, hence the semantic scheduler determines the lowest priority level for the Attribute #3. Similarly, metadata 411 is considered to have the least importance in terms of required protection levels, hence the semantic scheduler determines the lowest protection level for the metadata 411.

Based on the determinations, the semantic scheduler may schedule transmissions for each information in an order based on the determined priority levels. The semantic scheduler may further determine encoding configurations for each information based on the determined protection levels for their transmissions. The semantic scheduler may operate as provided in this disclosure with different scheduling configurations as well. For this illustrative example, the semantic scheduler may first transmit information with respect to the Attribute #1, then Attribute #2, and then metadata 411. For example, if a new set of information to be transmitted arrives at the semantic scheduler (e.g. information with respect to another received raw data for a next instance of time, Time #6-10), the semantic scheduler may determine priority and protection levels for the new set of information. In that case, the semantic scheduler may transmit information with respect to Attribute #1 about the received raw data with respect to Time #6-10 before the semantic scheduler schedules transmission of Attribute #3 or the raw data 410 with respect to the received raw data for Time #5-10. In various examples, information that is not scheduled for an operation with respect to the previous instance of time (or a number of previous instances of time) may be removed for the queue of scheduling a transmission.

In various examples, the semantic scheduler may schedule the transmission of the scheduling information indicating the configuration of the scheduled transmissions with the highest possible priority, and possibly in advance of transmissions of the one or more data elements, the metadata, and the received raw data, so that the receiving entity may obtain the scheduling information beforehand.

The processor 300 may further include a controller 304 to encode the information according to the scheduling configuration that the semantic scheduler 303 provides and control the communication interface to transmit communication signals according to the scheduling configuration. In more detail, the controller 304 may encode the one or more data elements, the metadata, and the received raw data based on instructions that the semantic scheduler 303 provides especially in terms of encoding configuration. The controller 304 may further control the communication interface to transmit the information according to the scheduling configuration and also based on other indicators of the encoding configuration with respect to modulation scheme and transmit power. Finally, the communication device may transmit the encoded information to the receiving entity via the communication interface.

In accordance with various aspects of this disclosure, the processor 300 may extract the semantic information using an artificial intelligence/machine learning model (AI/ML). The processor 300 may provide the received raw data to an input of the AI/ML. The AI/ML may include a trained AI/ML. The AI/ML may be configured to provide an output including the extracted semantic information which the processor 300 may schedule for the transmission as provided in this disclosure. The processor 300 may implement the AI/ML based on a plurality of machine model parameters stored in the memory (e.g. the memory 203), or provide the received raw data to an external processor or an external computing device that is configured to implement the AI/ML as provided in this disclosure. The processor 300 may include an accelerator or a neuromorphic processor to implement the AI/ML. The output of the AI/ML may further include the metadata associated with the extracted semantic information.

FIG. 5 shows an example of a processor of a communication device 200 according to various aspects provided in this disclosure. The processor 500 is depicted to include various functional modules that are configured to provide various functions respectively. The skilled person would recognize that the depicted functional modules are provided to explain various operations that the processor 500 may be configured to. The processor 500 includes similar modules as provided with respect to the FIG. 3 such as a semantic scheduler 503 and a controller 504. The details of these modules will not be repeated here, and accordingly, the semantic scheduler 503 may perform the same operations with the semantic scheduler 303, and the controller 504 may perform the same operations with the controller 304 as provided with respect to FIG. 3.

The processor 500 may further include an AI/ML module 501. The AI/ML module 501 is depicted as it is implemented in the processor 500 only as an example, and any type of AI/ML implementations which may include the implementation of the AI/ML in an external processor, such as an accelerator, a graphics processing unit (GPU), a neuromorphic chip, or in a cloud computing device, or in a memory (e.g. the memory 203) may also be possible according to any methods.

The AI/ML module 501 may implement the AI/ML. The AI/ML module 501 may receive input including the received raw data, and the AI/ML module 501 may provide output including the extracted semantic information and the metadata associated with the extracted semantic information based on the input data. The controller 503 may further control the AI/ML module 501. The controller 503 may provide the input data to the AI/ML 501, or provide the AI/ML module 501 instructions to perform the extraction.

The AI/ML 501 module may implement an AI/ML. The AI/ML may be any type of machine learning model configured to receive the input data and provide an output as provided in this disclosure. The AI/ML may include any type of machine learning model suitable for the purpose. The AI/ML may include a neural network, including various types of neural networks. The neural network may be a feed-forward neural network in which the information is transferred from lower layers of the neural network close to the input to higher layers of the neural network close to the output. Each layer includes neurons that receive input from a previous layer and provide an output to a next layer based on certain weight parameters adjusting the input information.

The AI/ML may include a convolutional neural network (CNN), which is an example for feed-forward neural networks that may be used for the purpose of this disclosure, in which one or more of the hidden layers of the neural network include a convolutional layer that performs convolutions for their received input from a lower layer. The CNNs may be helpful for pattern recognition and classification operations. The CNN may further include pooling layers, fully connected layers, and normalization layers.

The AI/ML may include a recurrent neural network in which the neurons transfer the information in a configuration that the neurons may transfer the input information to a neuron of the same layer. Recurrent neural networks (RNNs) may help to identify patterns between a plurality of input sequences, and accordingly, RNNs may identify temporal pattern provided as a time-series data and perform predictions based on the identified temporal patterns. In various examples of RNNs, long short-term memory (LSTM) architecture may be implemented. The LSTM networks may be helpful to perform classifications, and processing, and predictions using time series data.

The AI/ML may include an LSTM network including a network of LSTM cells that may process the attributes provided for an instance of time from the input according to the attributes provided for the instance of time and one or more previous outputs of the LSTM that have taken in place in previous instances of time, and accordingly, obtain the output. The number of the one or more previous inputs may be defined by a window size. The window size may be arranged according to the processing, memory, and time constraints and the input data. The LSTM network may process the features of the received raw data and determine a label for an attribute for each instance of time according to the features.

In various examples, the neural network may be configured in top-down configuration in which a neuron of a layer provides output to a neuron of a lower layer, which may help to discriminate certain features of an input.

The AI/ML may include a reinforcement learning model. The reinforcement learning model may be modeled as a Markov decision process (MDP). The MDP may determine an action from an action set based on a previous observation which may be referred to as a state. In a next state, the MDP may determine a reward based on the next state and the previous state. The determined action may influence the probability of the MDP to move into the next state. Accordingly, the MDP may obtain a function that maps the current state to an action to be determined with the purpose of maximizing the rewards.

In one example, the reinforcement learning model may be based on Q-learning to extract the semantic information in the particular state according to a Q-function based on AI/ML parameters. The Q-function may be represented with an equation:

Q_{new}(sₜ,aₜ)←(1−α)Q(sₜ,aₜ)+α(r+γ maxa(Q(sₜ+1),a))

In the Q-function equation, s representing the state and a representing the action, indicating all state-action pairs with an index t, the new Q value of the corresponding state-action pair t is based on the old Q value for the state-action pair t and the sum of the reward r obtained by taking action aₜ in the state sₜ with a discount rate γ that is between 0 and 1, in which the weight between the old Q value and the reward portion is determined by the learning rate α. With respect to this illustrative example, the received raw data may indicate the state, and the actions may include classifying one or more attributes for the received raw data.

In accordance with various aspects of this disclosure, the AI/ML may include a multi-armed bandit reinforcement learning model. In multi-armed bandit reinforcement learning models, the model may test available actions at substantially equal frequencies. With each iteration, the AI/ML may adjust the machine learning model parameters to select actions that are leading better total returns with higher frequencies at the expense of the remaining selectable actions, resulting in a gradual decrease with respect to the selection frequency of the remaining selectable actions, and possibly replace the actions that are gradually decreased with other selectable actions. In various examples, the multi-armed bandit RL model may select the actions irrespective of the information representing the state. The multi-armed RL model may also be referred as one-state RL, as it may be independent from the state. Accordingly, with respect to examples provided in this section, the AI/ML may include a multi-armed bandit reinforcement learning model configured to select actions without any information indicating the state.

The AI/ML may include a trained AI/ML that is configured to provide the output as provided in various examples in this disclosure based on the input data. The trained AI/ML may be obtained via an online and/or offline training. For the offline training, a training agent may train the AI/ML based on conditions of the communication device including the structure of the received raw data, attributes that are obtainable from the received raw data, information that is extractable from the received raw data, etc. in a past instance of time. Furthermore, the training agent may train the AI/ML (e.g. by adjusting the machine learning model parameters stored in the memory) using online training methods based on the latest (or actual) implementation conditions, such as the quality of the communication channel between the communication device and a receiving entity, etc. Furthermore, the processor 500 may further optimize the AI/ML based on previous inference results, and possibly based on a performance metric with respect to the previous inference results and the effects obtained in response to the previous inference results.

The training agent may train the AI/ML according to the desired outcome. The training agent may provide the training data to the AI/ML to train the AI/ML. The training data may include input data with respect to simulated operations. The training data may include training input data, generated in response to other communication activities. In various examples, the training agent may obtain the training data based on different contents with respect to the received training data in terms of attributes, etc. The training agent may store the information obtained from the extraction of the semantic information and the metadata performed in different conditions to obtain the training data.

The processor 500 may implement the training agent, or another entity that may be communicatively coupled to the processor 500 may include the training agent and provide the training data to the device, so that the processor 500 may train the AI/ML. In various examples, the device may include the AI/ML in a configuration that it is already trained (e.g. the machine model parameters in the memory are set). It may desirable for the AI/ML module 501 itself to have the training agent, or a portion of the training agent, in order to perform optimizations according to the output of the inferences to be performed as provided in this disclosure. The AI/ML module 501 may include an execution module and a training module that may implement the training agent as provided in this disclosure for other examples.

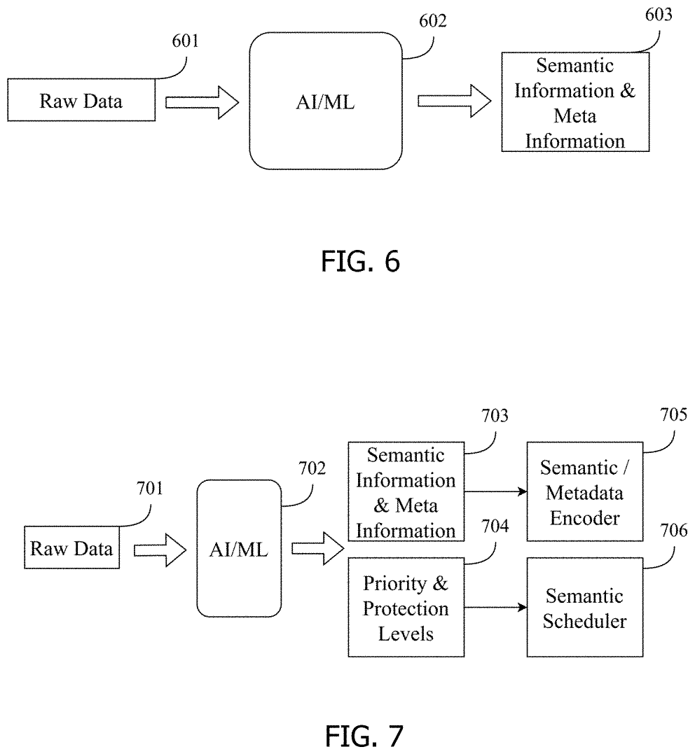

FIG. 6 shows an example of an AI/ML, which the AI/ML module 501 may implement. The AI/ML 602 may include any type of AWL, in which some of the examples are referred to with respect to FIG. 5. The skilled person would appreciate that AI/ML may include one or more AI/ML that are suitable to extract the semantic information based on the received raw data that may be suitable for the purpose of extracting the semantic information from the received raw data. Accordingly, the AI/ML 602 may include different types of AI/MLs based on the relationship between the received raw data and obtainable and expected semantic information to be extracted from the received raw data. For an application according to the audio processing, an exemplary AI/ML may include an LSTM network, while for an application according to image or video processing, an exemplary AI/ML may include a CNN.

The AI/ML 602 may receive input 601 including the received raw data, and provide output 603 including semantic information with respect to the content that the received raw data provides (such as attributes with respect to location of objects, velocity, etc.). The output 603 of the AI/ML 602 may further include the meta information associated with the output semantic information.

Referring back to FIG. 5, the processor 500 may further include a semantic/metadata encoder 502. Once the AI/ML module 501 obtains output including the semantic information with respect to the received raw data and the associated metadata, the semantic/metadata encoder 502 may encode the semantic information and the meta information accordingly to obtain the one or more data elements with respect to the output semantic information and the metadata associated with the output semantic information.

FIG. 7 shows another example of an AI/ML, which the AI/ML module 501 may implement. The AI/ML 702 may include one or more AI/ML suitable for the received raw data and obtainable semantic information from the received raw data. The AI/ML 702 may receive input 701 including the received raw data and provide a first output 703 including semantic information and meta information and a second output 704 including estimated priority and protection levels with respect to the semantic information and the meta information. The AI/ML module 501 may provide the first output 703 to the semantic/metadata encoder 705 to obtain one or more data elements with respect to the output semantic information and the metadata. The AI/ML module 501 may provide the second output 704 to the semantic scheduler 706, so that the semantic scheduler 706 may schedule the transmissions based on the second output 704 indicating priority and protection levels with respect to the output semantic information and the metadata.

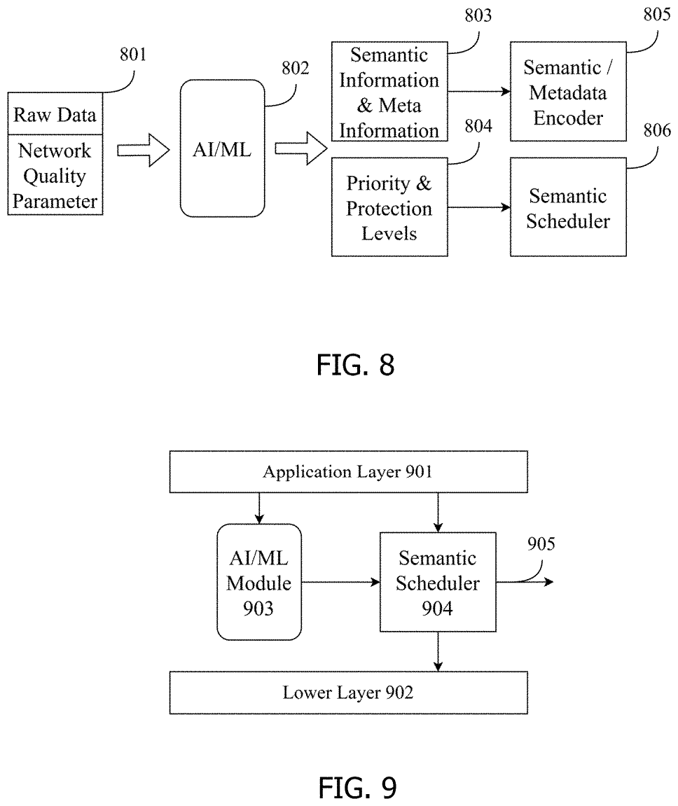

FIG. 8 shows another example of an AI/ML, which the AI/ML module 501 may implement. The AI/ML 802 may include one or more AI/ML suitable for the received raw data and obtainable semantic information from the received raw data. The AI/ML 802 may receive input 801 including the received raw data and the network quality parameter indicating the state of the communication channel for an output that is aware of network conditions. The AI/ML 802 may provide a first output 803 including semantic information and meta information and a second output 804 including estimated priority and protection levels with respect to the semantic information and the meta information. The AI/ML module 501 may provide the first output 803 to the semantic/metadata encoder 805 to obtain one or more data elements with respect to the output semantic information and the metadata. The AI/ML module 501 may provide the second output 804 to the semantic scheduler 806, so that the semantic scheduler 806 may schedule the transmissions based on the second output 804 indicating priority and protection levels with respect to the output semantic information and the metadata.

Furthermore, the semantic scheduler 503 may provide scheduling and the controller 504 may provide controlling functions as explained with respect to FIG. 3, and accordingly, the communication device may transmit communication signals to the receiving entity.

FIG. 9 shows an illustration with respect to AI/ML module. In accordance with various aspects of this disclosure, AI/ML modules may use input data from application layer 901 of the protocol stack according to a communication reference model. Accordingly, in various examples that processors may implement the AI/ML module 903 (e.g. the AI/ML module 501) as provided in this disclosure, the processors may perform application layer functions for the application layer 901 of a communication reference model (e.g. OSI) and lower layer functions for a lower layer 902 of the communication reference model that is lower than the application layer. In various examples, the lower layer 902 may include a Network Access layer, Medium Access Control (MAC) layer, or physical (PHY) layer, and in particular, a lower PHY layer.

The AI/ML module 903 may obtain the received raw data using application layer functions, and accordingly, the AI/ML module 903 may be at the application layer 901. In various aspects, the AI/ML module 903 may be at a lower layer than the application layer 901, and the AI/ML module 903 may receive the received raw data from the application layer functions via cross-layer information. The AI/ML module 903 may operate at the middleware of the communication device.

Furthermore, the semantic scheduler 904 (e.g. the semantic scheduler 503) may also operate at a layer lower than the application layer 901. The semantic scheduler 904 may operate at a layer between the application layer 901 and the lower layer 902. The semantic scheduler 904 may operate at the lower layer 902. In this illustrative example, the semantic scheduler 904 is depicted as operating at a layer between the application layer 901 and the lower layer 902. In one example, the semantic scheduler 904 may also operate at the middleware of the communication device.

The semantic scheduler 904 may receive the semantic information from the AI/ML module 903 via cross-layer information. Furthermore, the semantic scheduler 904 may receive the received raw data from the application layer 901 either using the application layer functions, or from the application layer functions via cross-layer information. The semantic scheduler 904 may further receive the network quality parameter from the lower layer 902 using the lower layer functions, or from the lower layer functions via cross-layer information. In various examples, the semantic scheduler 904 may also provide the network quality parameter to the AI/ML module 903 for a network aware inferencing. It may be desirable to share the network quality parameter via cross-layer information with an intention to remove the dependency to the network state for the development purposes and provide joint optimization options on different layers.

Furthermore, the semantic scheduler 904 may provide 905 the scheduling information over a semantic channel to the receiving entity. The semantic channel may include a physical channel that is different from the communication channel that the communication device may use to transmit data to the receiving entity. The semantic channel may include a logical channel establishing a link between different layers of the protocol stack.

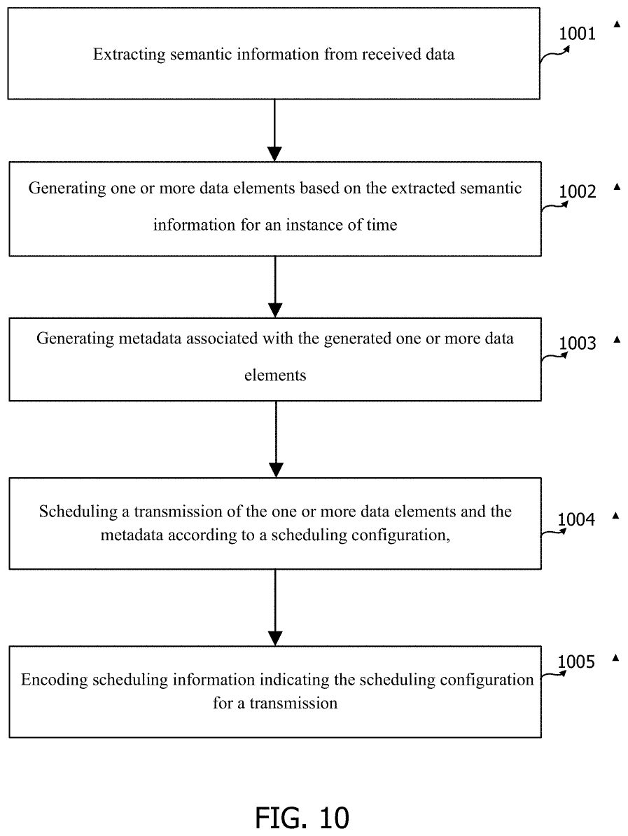

FIG. 10 shows an example of a method. The method may include extracting 1001 semantic information from received data, generating 1002 one or more data elements based on the extracted semantic information for an instance of time, generating 1003 metadata associated with the generated one or more data elements, scheduling 1004 a transmission of the one or more data elements and the metadata according to a scheduling configuration, encoding 1005 scheduling information indicating the scheduling configuration for a transmission. A non-transitory computer-readable medium may include instructions which, when executed by a processor, cause the processor to perform the method.

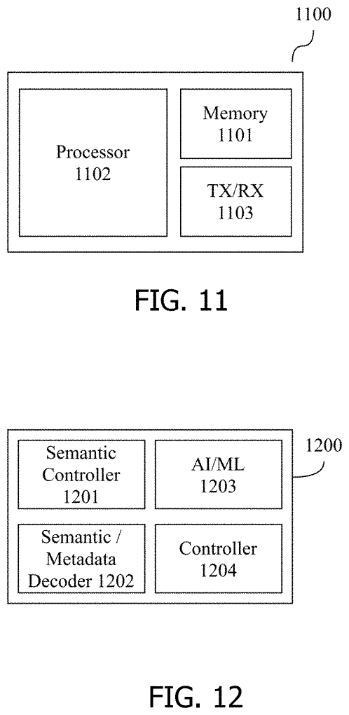

FIG. 11 shows an example of a communication device according to various aspects of this disclosure. The communication device 1100 may include a computing device of any types that may process data and transmit communication signals as provided in this disclosure. For example, the communication device 1100 may include a terminal device, a computer e.g. a desktop computer or a tablet computer, a mobile device, a mobile communication device e.g. a mobile terminal or a smartphone, a wearable device e.g. a smart watch or a smart googles, a device for a smart home (domotics), an internet of things (IoT) device, a vehicle computer e.g. an autonomous vehicle or an automated and/or assisted driving vehicle. The communication device 1100 may include components that may include hardware components and/or software components. In accordance with various aspects of the disclosure, the communication device 1100 may be deemed as a receiving entity.

The communication device 1100 may include a memory 1101 to perform various operations as provided in this disclosure. In various examples, the memory 1101 may store the received data, and the processor 1102 may process the received data by accessing the received data in the memory 1101. For this illustrative example, the received data may refer to the data that the communication device 1100 may receive using a communication interface.

The communication device 1100 may include a processor 1102. The processor 1102 may include one or more processors or processing units that are configured to perform various functions. For example, the processor 1102 may include a central processing unit, a graphics processing unit, a hardware acceleration unit, a neuromorphic chip, and/or a controller. The processor 1102 may be implemented in one processing unit, e.g. a system on chip (SOC), or a processor. The processor 1102 is exemplified herein as it includes various units that are directed to various functions for efficient processing.

The communication device 1100 may further include a communication interface including at least one receiving circuit 1103. The communication interface may include a transmitting circuit 1103 as well, and in this case, the transmitting and the receiving circuit 1103 may be referred to as TX/RX circuit 1103. The communication interface may support communication via various communication technologies. For example, the communication interface (e.g. TX/RX circuit 1103) may include components that are configured to perform radio communication technologies, as provided exemplarily with respect to FIG. 1. Accordingly, the communication interface may include one or more radio communication circuits to communicate according to one or more radio communication technologies. Furthermore, the communication interface may include components that are configured to perform wired communication technologies, e.g. a circuitry configured to perform communication according to Universal Serial Bus (USB) protocol, a circuitry for Universal Asynchronous Receiver/Transmitter (UART) communication, a circuitry for RS-232 communication, etc. Once the TX/RX circuit 1103 receives communication signals, the TX/RX circuit 1103 may apply various receiving schemes including down-converting, demodulation, etc.

The processor 1102 may obtain the data that was received by the communication interface of the communication device 1100 by controlling the TX/RX circuit 1103, which will be referred to with respect to this illustrative example as “received data”. The processor 1102 may use any known techniques to obtain the received data. The processor 1102 may decode the received data to obtain a plurality of data elements that may correspond to a plurality of one or more data elements with respect to the various examples of this disclosure, one or more metadata associated with at least some of the plurality of data elements, and the scheduling configuration indicating the relationship between the plurality of data elements and the one or more metadata.

The scheduling information may include instructions with respect to how to obtain information indicating the content with respect to the plurality of data elements, one or more metadata. In various examples, the scheduling information may indicate how the transmitting entity has scheduled the transmission of extracted semantic information and the metadata associated with the extracted semantic information based on a raw data with respect to the content related to an instance of time, so that the processor 1102 may obtain the extracted semantic information and the metadata associated with the extracted semantic information for the content related to that particular instance of time. In various examples, the received data may further include raw data that the transmitting entity may transmit, and the scheduling configuration may further indicate the relationship between the plurality of data elements, the one or more metadata, and the raw data.

Accordingly, the processor 1102 may identify one or more data elements with respect to the extracted semantic information for the content related to an instance of time from the plurality of data elements based on the scheduling information and obtain the semantic data including the identified one or more data elements. Furthermore, the processor 1102 may also identify metadata associated with the extracted information for the content related to the instance of time from one or more received metadata based on the scheduling information.

In various examples, the scheduling information may indicate an application of various decoding configurations with respect to the received data. The processor 1102 may accordingly apply various decoding configurations with respect to the received data. The processor 1102 may control the TX/RX circuit 1103 to apply various demodulation techniques based on the indication of the scheduling information with respect to the decoding configuration. In various examples, the processor 1102 may further control the TX/RX circuit 1103 to adjust amplification parameters based on the transmit power configuration that the scheduling information may indicate.

In various examples, the scheduling information may indicate reception of raw data. Accordingly, the processor 1102 may decode the raw data and provide the raw data for a further processing to obtain information about the content that the raw data provides. The further processing may include a processing to extract semantic information from the raw data by similar techniques as provided with respect to the transmitting entity.

The semantic data and the metadata may include information with respect to a plurality instance of time. Furthermore, at least each semantic data may indicate information with respect to an instance of time. The identified one or more data elements of the semantic data may include information indicating a detected attribute in a time-series configuration. In any event, either from one semantic data or a plurality of semantic data, the processor 1102 may obtain information of a detected attribute for a plurality of instances of time. The processor 1102 may obtain information with respect to at least one detected attribute according to the received data in a time-series configuration.

The processor 1102 may further detect an anomaly at the one or more data elements indicating the detected feature based on the information in the time-series configuration. For example, time-series data may include information with respect to each of the detected attributes for a plurality instances of time, each data element of the time-series data represent a detected attribute at an instant of time. The processor 1102 may detect the anomaly based on the relationship and/or correlation between data elements for a detected attribute.

The processor 1102 may further generate one or more data elements based on the extracted semantic information from the received raw data. The processor 1102 may further generate metadata associated with the one or more data elements. In various examples, the processor 1102 may generate the metadata based on the received raw data and based on the extracted semantic information. Once the processor 1102 obtains the semantic data and the metadata from the received data, which the semantic data and the metadata relates to the particular instance of time, the processor 1102 may obtain the semantic information based on the semantic data and the metadata. In various examples, the obtained semantic information may include one or more detected attributes at the particular instance of time.

Once the processor 1102 generates the metadata and the one or more elements with respect to the received raw data, the processor 1102 may schedule a transmission of the one or more data elements and the metadata according to a scheduling configuration. It may be desirable to transmit the one or more elements and the metadata by scheduling different transmissions to a receiving entity as the metadata and the one or more elements generated with respect to the extracted semantic information. In various examples, one may be scheduled before the other with an intention to reduce overhead and handle the network conditions by prioritizing the transmission of the critical data.

Furthermore, it may be desirable to schedule transmissions of the one or more data elements, and the metadata including information that is related to the one or more data elements with different frequencies. For example, the transmission of the one or more data elements may be expected more frequently, and the information that the metadata may include may change in a less frequent manner than the information that the one or more data elements may convey to the receiving entity.

Furthermore, the processor 1102 may decode scheduling information indicating the scheduling configuration for the transmission of the one or more data elements and the metadata with an intention to obtain an indication to provide a kind of mapping with respect to the extracted semantic information from the received raw data for an instance of time according to the one or more data elements and the metadata.

FIG. 12 shows an example of a processor of a communication device 1100 according to various aspects provided in this disclosure. The processor 1200 is depicted to include various functional modules that are configured to provide various functions respectively. The skilled person would recognize that the depicted functional modules are provided to explain various operations that the processor 1200 may be configured to.

The processor 1200 may include a semantic controller 1201 configured to control the communication with the receiving entity. The semantic controller 1201 may receive the scheduling information indicating the scheduling configuration with respect to the received data and provide instructions to a controller 1204 to perform demodulation and decoding operations and to a semantic/metadata decoder 1202 to perform operations to obtain the semantic information and the metadata associated with the semantic information as exemplarily provided with respect to the FIG. 11. Furthermore, the processor 1200 may include a semantic/metadata decoder 1202 to obtain the semantic information and the metadata from the received data based on the instructions that the semantic controller provides according to the scheduling information.

The processor 1200 may further include an AI/ML module 1203. The AI/ML module 1203 is depicted as it is implemented in the processor 1200 only as an example, and any type of AI/ML implementations which may include the implementation of the AI/ML in an external processor, such as an accelerator, a graphics processing unit (GPU), a neuromorphic chip, or in a cloud computing device, or in a memory (e.g. the memory 1101) may also be possible according to any methods.

The AI/ML module 1203 may implement an AI/ML. The AI/ML may be any type of machine learning model configured to receive the input data and provide an output as provided in this disclosure. The AI/ML may include any type of machine learning model suitable for the purpose. The AI/ML may include similar features as provided with respect to the FIG. 5.

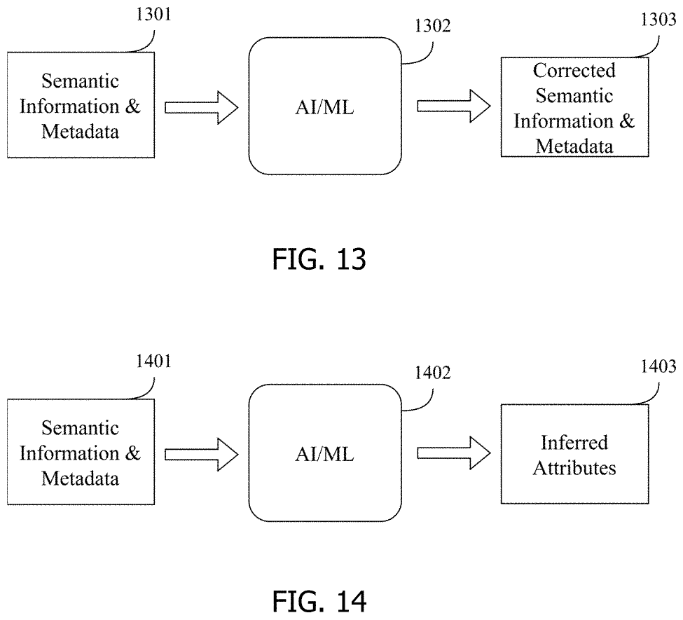

FIG. 13 shows an example of an AI/ML, which the AI/ML module 1203 may implement. In accordance with various aspects of this disclosure, the processor may operate the AI/ML module 1203 to detect anomalies in the received semantic information and metadata and correct the anomalies by relying on the correlation between the detected attributes of a plurality of instances of time. Accordingly, the AI/ML 1302 may receive input 1301 including received semantic information and metadata for a plurality of instance of time. The input 1301 may include data in a time-series configuration. The AI/ML 1302 may be configured to provide an output including the corrected semantic information and metadata for each instances of time. The AI/ML 1302 may include a trained AI/ML that is configured to detect anomalies and correct data elements with anomalies. For example, the AI/ML 1302 may include an LSTM network trained for the purpose of correcting the semantic information and metadata.

FIG. 14 shows an example of an AI/ML, which the AI/ML module 1203 may implement. In accordance with various aspects of this disclosure, the processor may operate the AI/ML module 1203 to interpret the received semantic information and metadata to obtain more information with respect to the raw data that the transmitting entity has extracted the received semantic information and the metadata from. Accordingly, the AI/ML 1402 may receive input 1401 including received semantic information and metadata and the AI/ML 1402 may be configured to provide an output including one or more inferred attributes that are different from the detected attributes. The AI/ML 1402 may include a trained AI/ML that is configured to infer more attributes with respect to the raw data based on received input including one or more detected attributes.

Referring back to FIG. 12, the AI/ML module 1203 may alternatively implement an AI/ML configured to receive the received data and the scheduling information and provide an output including the semantic information and the metadata.

In accordance with various aspects of this disclosure, any of the AI/MLs that the AI/ML module 1203 may implement, may include a trained AI/ML that is configured to provide the output as provided in various examples in this disclosure based on the input data. The trained AI/ML may be obtained via an online and/or offline training. For the offline training, a training agent may train the AI/ML based on conditions of the communication device including the structure of the received raw data, attributes that are obtainable from the received raw data, information that is extractable from the received raw data, etc. in a past instance of time. Furthermore, the training agent may train the AI/ML (e.g. by adjusting the machine learning model parameters stored in the memory) using online training methods based on the latest (or actual) implementation conditions, such as the quality of the communication channel between the communication device and a receiving entity, etc. Furthermore, the processor may further optimize the AI/ML based on previous inference results, and possibly based on a performance metric with respect to the previous inference results and the effects obtained in response to the previous inference results.

The training agent may train the AI/ML according to the desired outcome. The training agent may provide the training data to the AI/ML to train the AI/ML. The training data may include input data with respect to simulated operations. The training data may include training input data, generated in response to other communication activities. In various examples, the training agent may obtain the training data based on different contents with respect to the received training data in terms of attributes, etc. The training agent may store the information obtained from the extraction of the semantic information and the metadata performed in different conditions to obtain the training data.

The processor 1200 may implement the training agent, or another entity that may be communicatively coupled to the processor 1200 may include the training agent and provide the training data to the device, so that the processor 1200 may train the AI/ML. In various examples, the device may include the AI/ML in a configuration that it is already trained (e.g. the machine model parameters in the memory are set). It may desirable for the AI/ML module 1203 itself to implement the training agent, or a portion of the training agent, in order to perform optimizations according to the output of the inferences to be performed as provided in this disclosure. The AI/ML module 1203 may include an execution module and a training module that may implement the training agent as provided in this disclosure for other examples.

In accordance with various aspects of this disclosure, the training agent may train the respective AI/ML based on one or more communication medium parameters with respect to the communication medium that the communication device 1100 receives the received data. The training agent may train the AI/ML with a supervised training. During the supervised training for the AI/ML, the training agent may augment the training data by incorporating the effects of network transmission. The training agent may derive the effects to be incorporated by performing various types of simulations to corrupt the training data. For example, the training data may include distorted speech, corrupted images/video, missing text, etc. based on the purpose of the AI/ML. It may be desirable to use such augmented dataset to train the AI/ML with an intention to improve the performance of the AI/ML for inferencing at the receiving entity by using the data obtained over the network.

Furthermore, the training agent may train the AI/ML by considering the actual network state in addition to the training data. The training agent may also provide the information indicating one or more communication medium parameters (e.g. the network quality parameter) as an input into the training process of the AI/ML with an intention to train the AI/ML for the joint optimization task of accounting for the impairments introduced in network transmission. Accordingly, any one of the AI/ML provided with respect to the receiving entity may be configured to receive the input data including one or more communication medium parameters providing indication with respect to the communication medium (e.g. the network quality parameter, estimated channel parameters, etc.).

For this purpose, the training agent may train the AI/ML based on or more communication medium parameters with respect to the communication medium between the transmitting entity and the communication device 1100. As indicated, the AI/ML may be configured to operate based on machine learning model parameters stored in the memory 1101. The memory 1101 may further include the training data for the training agent. The processor 1200 may adjust the training data based on one or more communication medium parameters. The processor 1200 may determine the one or more communication parameters based on a network simulation that the processor 1200 may perform.

In various aspects, the communication device 1100 may further include a measurement circuit to perform measurements with respect to the communication medium, and the processor may perform various channel estimation techniques with respect to the communication medium to estimate the one or more communication medium parameters. Furthermore, the training agent may train the AI/ML with an input data including the training agent and the one or more communication parameters. The training agent may optimize the machine learning models according to the output of the AI/ML and a supervising input.

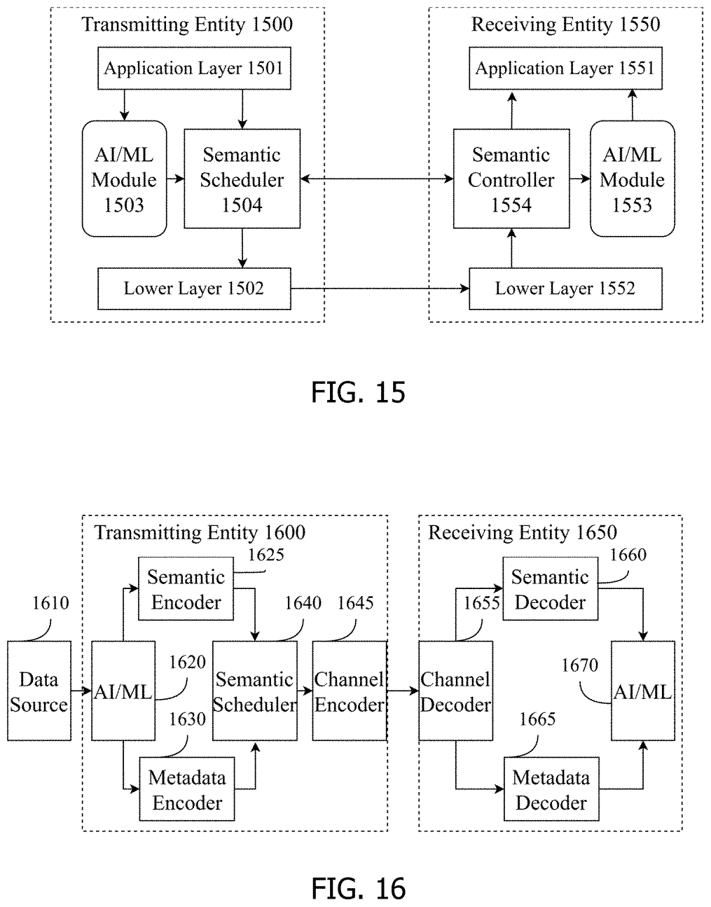

FIG. 15 shows an illustration with respect to communication devices according to various aspects of this disclosure. A first communication device which may be referred to as transmitting entity 1500 may include a protocol stack including an application layer 1501 providing application layer functions, a lower layer 1502 providing lower layer functions, an AI/ML module 1503, and a semantic scheduler 1503 which the details of are provided in FIG. 9.

A second communication device which may be referred to as receiving entity 1550 (e.g. the communication device 1100) may operate in a similar manner. The processor of the receiving entity 1550 may perform application layer functions at the application layer 1551 and lower layer functions at the lower layer 1552. In accordance with various aspects of this disclosure, a semantic controller 1554 (e.g. the semantic controller 1201) may use input data from the lower layer 1552 that is lower than the application layer 1551 according to a communication reference model (e.g. OSI). In various examples, the lower layer 1552 may include a Network Access layer, Medium Access Control (MAC) layer, or physical (PHY) layer, and in particular, a lower PHY layer.

The semantic controller 1554 may operate at the lower layer 1552 or at a layer between the lower layer 1552 and the application layer 1551. In various examples, the semantic controller 1554 may also operate at the application layer 1551. Accordingly, the semantic controller 1554 may receive input data (e.g. plurality of data elements and one or more metadata) using lower layer functions, or from lower layer functions provided at the lower layer 1552 by cross-layer information. Furthermore, the semantic controller 1554 may receive the scheduling information from the semantic scheduler 1504 of the transmitting entity 1500. Although it may also be possible to receive the scheduling information from the lower layer 1552 as the received data, and the semantic channel may include a logical channel establishing a link between different layers of the protocol stack, the semantic controller 1554 may receive the scheduling information over a physical semantic channel that is different from the communication channel that the communication devices may use to communicate other data (e.g. the plurality of data elements or one or more metadata at the receiving entity 1550) from the transmitting entity 1500. The semantic channel may include a physical channel. In various examples, the semantic scheduler 1504 and the semantic controller 1554 may operate at a dedicated layer (e.g. a semantic layer).

The receiving entity 1550 may also include AI/ML module 1553 (e.g. AI/ML modules provided with respect to the communication device 1100, AI/ML module 1203) that may receive input data from the semantic controller 1554. Accordingly, in various examples that processors may implement the AI/ML module 1553 as provided in this disclosure, the AI/ML 1553 module may receive input from the semantic controller 1554 either according to layer functions of the respective layer that the semantic controller 1554 and the AI/ML module 1553 may operate or via cross-layer information. The AI/ML module 1553 may provide the outputs to the application layer 1551 using the application layer functions, or to the application layer functions via cross-layer information.

FIG. 16 shows an example of a communication system according to various aspects of this disclosure. The communication system may include a transmitting entity 1600 (e.g. communication device 200) and a receiving entity 1650 (e.g. communication device 1100). As provided in various examples in this disclosure, the transmitting entity 1600 may receive raw data from a data source 1610. In some examples, the transmitting entity 1600 may include the data source 1610. The transmitting entity 1600 may include an AI/ML module 1620 to process received raw data and provide output including semantic information and metadata. The transmitting entity 1600 may further include a semantic encoder 1625 that may receive the semantic information and encode the semantic information. The transmitting entity 1600 may further include a metadata encoder 1630 that may receive the meta information and encode metadata. The transmitting entity 1640 may further include a semantic scheduler 1640 to schedule transmission of the semantic data and the metadata. The transmitting entity may further include a channel encoder 1645 to encode data to be transmitted from a communication channel 1645 to the receiving entity 1650.

The receiving entity 1650 may include a channel decoder 1655 to decode received data. The receiving entity 1650 may further include a semantic decoder 1660 to decode semantic data and a metadata decoder 1665 to decode metadata. The receiving entity 1650 may further include an AI/ML 1670 to analyze the decoded semantic data and the metadata as provided in this disclosure.

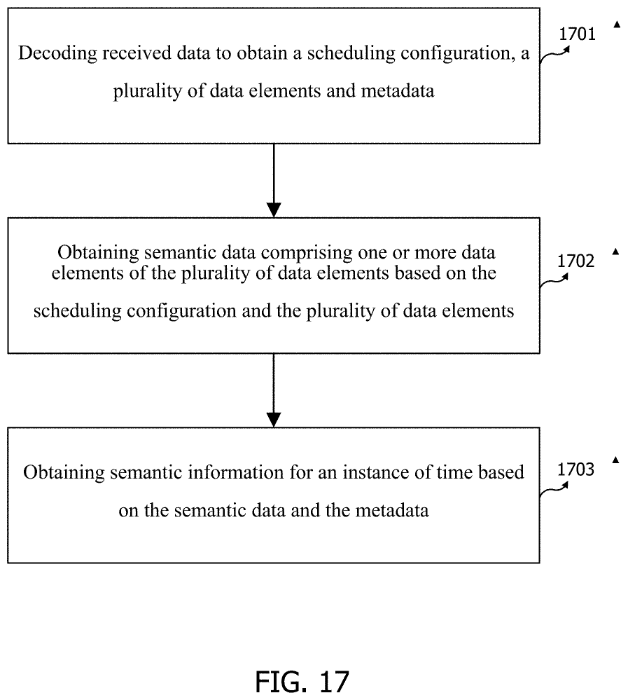

FIG. 17 shows an example of a method. The method may include decoding 1701 received data to obtain a scheduling configuration, a plurality of data elements and metadata, obtaining 1702 semantic data comprising one or more data elements of the plurality of data elements based on the scheduling configuration and the plurality of data elements, and obtaining 1703 semantic information for an instance of time based on the semantic data and the metadata. A non-transitory computer-readable medium may include instructions which, when executed by a processor, cause the processor to perform the method.

In accordance with various aspects of this disclosure, the nature of the semantic information may differ, and the meaning that semantic information may provide may be at various levels. Especially as the meanings that semantic information may provide may also vary according to different use cases, it may be desirable to arrange the communication of the semantic information between the transmitting entity and the receiving entity at different abstraction levels.

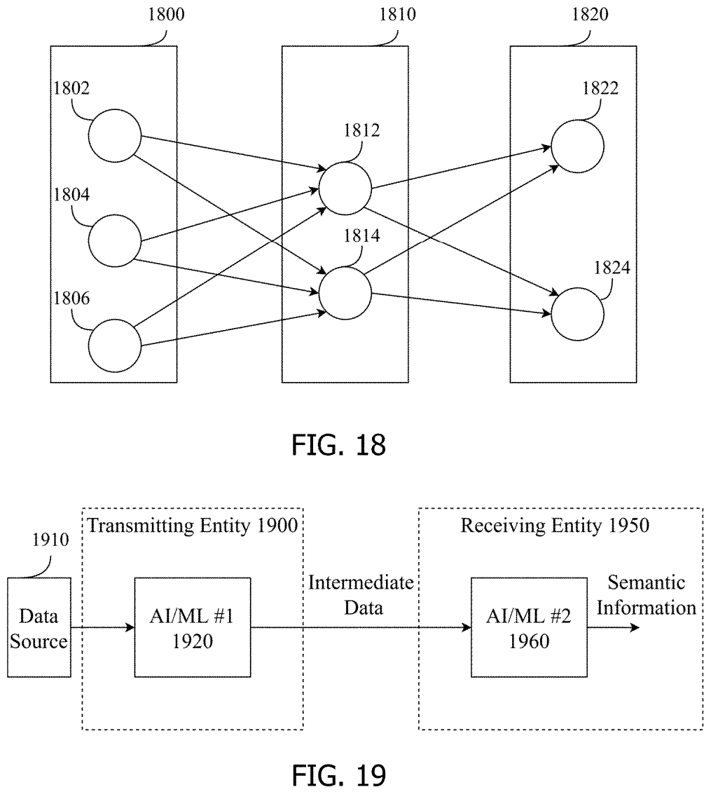

FIG. 18 shows an illustration of an AI/ML model including a neural network. The neural network may include a plurality of neurons 1802, 1804, 1806, 1812, 1814, 1822, 1824. The neural network may be structured in layers as in a first layer 1800 (e.g. input layer) including input neurons 1802, 1804, 1806, one or more intermediate layers 1810 (e.g. hidden layer) including intermediate neurons 1812, 1814, and an output layer 1820 including neurons 1822, 1824. The neural network may include further layers, and the layers (including the input layer, the output layer, and/or the middle layer) may include further neurons. The neurons may be grouped in a different manner, and/or one or more neurons of one of the layers may be configured to receive input only from a subset of a preceding layer. Similarly, one or more neurons of one of the layers may be configured to provide output only to a subset of the following layer. In a feed-forward neural network, each neuron may provide an output to the neurons of a next layer, and the last layer becomes the output layer 1820.

The neural network may receive input data from its input layer 1800, perform various kinds of analysis based on various parameters with respect to the machine learning model that the neural network may perform, such as a weight parameter and a bias parameter for each neuron, and after performing various calculations in the intermediate layers 1810, the neural network may provide the output from the output layer 1820.

In various examples, the neural network may be distributed (i.e. split) in two (or more) different entities in a manner that a first entity may perform a first portion of processing in terms of the AI/ML model (in this illustrative example, the neural network) based on the input data received from the input layer 1800 and a second entity may perform the remaining portion of the processing to obtain the output from the output layer 1820. In a manner that is similar to the operation of feed-forward neural networks, the first entity may send intermediate data as a result of the first portion of the processing based on the input data. The second entity may receive the intermediate data and may perform the remaining portion of the processing to obtain the output from the output layer. In this constellation, the intermediate data may become meaningful data for the second entity

The split with respect to the processing may be based on a predefined split configuration. For example, the first portion may include only the first layer, and the second portion may include intermediate layers and the output layer. The first portion may include the first layer and the one or more intermediate layers, and the second portion may include the output layer.

FIG. 19 shows an example of a communication system according to various aspects of this disclosure. In a similar operation with respect to FIG. 16, the communication system may include a transmitting entity 1900 and a receiving entity 1950 communicatively coupled over a communication channel. The transmitting entity 1900 may include an interface to receive raw data from a data source 1910 (e.g. a sensor). The transmitting entity 1900 may include the data source 1910.

For this illustrative example, the transmitting entity 1900 may include a first AI/ML module 1920 that is configured to receive an input including the received raw data, perform processing functions according to a first portion of an AI/ML, and provide an output including the intermediate data. The transmitting entity 1900 may transmit the intermediate data over the communication channel to the receiving entity 1950. The receiving entity 1950 may receive the intermediate data. The receiving entity 1950 may include a second AI/ML module 1960 that is configured to receive the intermediate data, perform processing functions according to a second portion of the AI/ML model, and provide an output including extracted semantic information from the content of the received raw data.

In other words, the AI/ML that is configured to extract semantic information based on the received raw data as provided in this disclosure is distributed between the transmitting entity 1900 and the receiving entity 1950 based on a predefined distribution configuration. Accordingly, instead of transmitting the received raw data, or extracted semantic information, the transmitting entity 1900 may transmit the intermediate data that any one of the AI/ML models may provide in this disclosure after a first portion of processing based on the input data, and the AI/ML module 1960 of the receiving entity 1950 may perform the remaining portion of the processing to obtain the semantic information.

Accordingly, the receiving entity 1950 (e.g. the communication device 1100) may include a processor that may decode data received from the transmitting entity over a communication medium. The decoded data may include a plurality of data elements (e.g. intermediate data) generated by a first portion of a distributed AI/ML. The distributed AI/ML may be configured to receive an input data including received raw data and provide an output indicating the semantic information. In various examples, the output of the distributed AI/ML may include the metadata.

The processor may provide the plurality of data elements to an input of the second portion of the AI/ML. The second portion of the AI/ML may be configured to provide an output including the semantic information (and the metadata) based on the input including the plurality of data elements.

In accordance with various aspects of this disclosure, the distributed AI/ML may include a trained AI/ML that is configured to provide the output including the semantic information based on the input data including the received raw data as a whole. The trained AI/ML may be obtained via an online and/or offline training. For the offline training, a training agent may train the distributed AI/ML on another computing device (or in either one of the transmitting entity or the receiving entity) as a whole by providing training input data and optimizing machine learning model parameters of the AI/ML based on the output. Once the training agent trains the distributed AI/ML, the training agent may send machine learning model parameters according to the predefined distribution configuration to the receiving entity and the transmitting entity.

Alternatively, or additionally, the training agent may train the distributed AI/ML by training each portion of the AI/ML based on their respective inputs and outputs by exchanging data between each portion of the AI/ML. The training agent may provide training input data to the first portion of the AI/ML that provides the output including the intermediate data. The training agent may then submit the intermediate data to the input of the second portion of the AI/ML that provide the output including the semantic information. Based on the output of the second portion of the AI/ML, the training agent may optimize the machine learning model parameters with respect to the both portions of the AI/ML according to regular training functions.

Furthermore, the training agent may train the distributed AI/ML (e.g. by adjusting the machine learning model parameters stored in the memory) using online training methods based on the latest (or actual) implementation conditions, such as the quality of the communication channel between the communication device and a receiving entity, etc. Furthermore, the processor may further optimize the distributed AI/ML based on previous inference results, and possibly based on a performance metric with respect to the previous inference results and the effects obtained in response to the previous inference results. In accordance with various aspects of the disclosure, the training agent may train the second portion of the AI/ML based on one or more communication parameters with respect to the communication medium between the transmitting entity and the receiving entity.

The training agent may train the AI/ML according to the desired outcome. The training agent may provide the training data to the AI/ML to train the AI/ML. The training data may include input data with respect to simulated operations. The training data may include training input data, generated in response to other communication activities. In various examples, the training agent may obtain the training data based on different contents with respect to the received training data in terms of attributes, etc. The training agent may store the information obtained from the extraction of the semantic information and the metadata performed in different conditions to obtain the training data.

The processor of the receiving entity 1950 may implement the training agent, or another entity that may be communicatively coupled to the processor of the receiving entity may include the training agent and provide the training data to the device, so that the processor of the receiving entity 1950 may train the AI/ML. In various examples, the device may include the AI/ML in a configuration that it is already trained (e.g. the machine model parameters in the memory are set). It may desirable for the AI/ML itself to have the training agent, or a portion of the training agent, in order to perform optimizations according to the output of the inferences to be performed as provided in this disclosure. The AI/ML may include an execution module and a training module that may implement the training agent as provided in this disclosure for other examples.

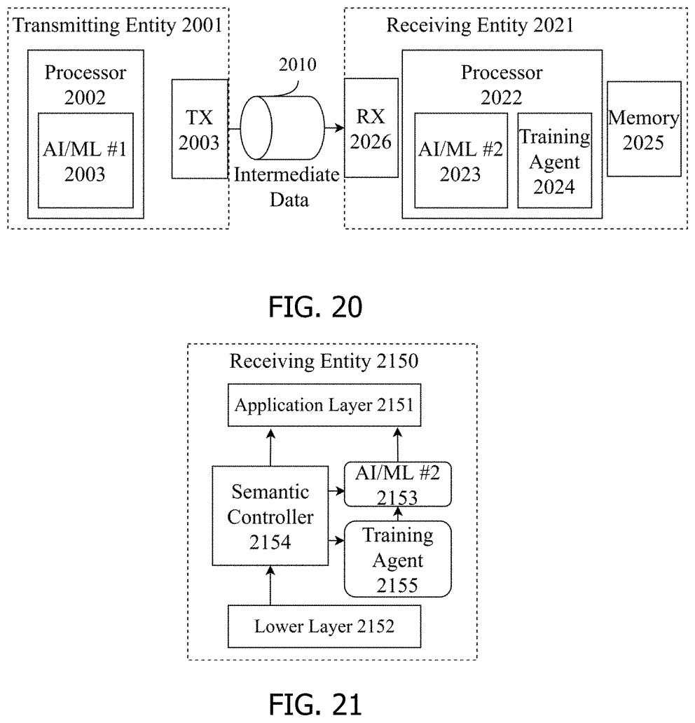

FIG. 20 shows an example of a communication system in accordance with various aspects of this disclosure. The communication system may include a transmitting entity 2001 including a processor 2002 that may implement the first portion of a distributed AI/ML 2003. The first portion of a distributed AI/ML may receive input data including received raw data and provide output including a plurality of data elements as intermediate data. As provided in this disclosure, the processor 2002 may selectively schedule the transmission of the received raw data and the transmission of the intermediate data. The transmitting entity 2001 may include a transmitter circuit 2003 to transmit the intermediate data. The transmitting entity 2001 may accordingly transmit communication signals to a communication medium 2010.

The communication system may include a receiving entity 2021 including a processor 2022 that may implement the second portion of the distributed AI/ML 2023. The distributed AI/ML (as a whole) may be configured to receive the input data including the received raw data and provide an output including the semantic information. The second portion of the distributed AI/ML 2023 may receive input including the plurality of data elements received from the transmitting entity 2001 and provide an output including the semantic information. The distributed AI/ML may include the same or a similar AI/ML as provided with respect to FIG. 19.

The processor 2022 may further include the training agent 2024 as provided in this disclosure to provide training functions for the second portion of the distributed AI/ML. In various examples, the training agent 2024 may further provide training functions for the first portion of the distributed AI/ML or for the distributed AI/ML as provided in this disclosure.

In accordance with various aspects of this disclosure, the training agent 2024 may train the second portion of the distributed AI/ML 2022 based on one or more communication medium parameters with respect to the communication medium that the receiving entity 2021 receives the plurality of data elements. The training agent 2024 may train the second portion of the distributed AI/ML 2022 with a supervised training. During the supervised training for the second portion of the AI/ML 2022, the training agent may adjust the training data by incorporating the effects of network transmission. The training agent 2024 may derive the effects to be incorporated by performing various types of simulations to corrupt the training data. For example, the training data may include intermediate data obtained by adjusting training data to simulate distorted speech, corrupted images/video, missing text, etc. based on the purpose of the distributed AI/ML. It may be desirable to use such an adjusted dataset to train the second portion of the AI/ML 2022 with an intention to improve the performance of the second portion of the AI/ML 2022 for inferencing at the receiving entity 2021 by using the data obtained over the network.

Furthermore, the training agent 2024 may train the second portion of the AI/ML 2022 by considering the actual network state in addition to the training data. The training agent 2024 may also provide the information indicating one or more communication medium parameters (e.g. the network quality parameter) as an input into the training process of the second portion of the AI/ML 2022 with an intention to train the second portion of the AI/ML 2022 for the joint optimization task of accounting for the impairments introduced in network transmission. Accordingly, the second portion of the AI/ML 2022 may be configured to receive the input data including one or more communication medium parameters providing indication with respect to the communication medium (e.g. the network quality parameter, estimated channel parameters, etc.) and the plurality of data elements (intermediate data).

For this purpose, the training agent 2024 may train the second portion of the AI/ML 2022 based on or more communication medium parameters with respect to the communication medium between the transmitting entity 2001 and the receiving entity 2021. The receiving entity 2021 may also include a memory 2025 configured to store machine learning model parameters, and the second portion of the AI/ML 2022 may be configured to provide the output based on the input according to the machine learning model parameters in the memory 2025. be configured to operate based on machine learning model parameters stored in the memory 2025. The memory 2025 may further include the training data for the training agent 2024. The training agent 2024 may adjust the training data based on one or more communication medium parameters. The processor 2022 may determine the one or more communication parameters based on a network simulation that the processor 2022 may perform.

In various aspects, the receiving entity 2021 may further include a receiver circuit 2026 couplable to the communication medium 2010. The receiver circuit 2026 may be a TX/RX circuit. The receiver circuit 2026 may include a measurement circuit to perform measurements with respect to the communication medium, and the processor 2022 may perform various channel estimation techniques with respect to the communication medium to estimate the one or more communication medium parameters. Furthermore, the training agent 2024 may train the second portion of the AI/ML 2022 with an input data including the training data and the one or more communication parameters. The training agent 2024 may optimize the machine learning model parameters in the memory 2025 according to the output of the second portion of the AI/ML 2022 and a supervising input.

FIG. 21 shows an illustration with respect to a communication device. The communication device may be the receiving entity as provided in this disclosure. The processor of the receiving entity 2150 may perform application layer functions at the application layer 2151 and lower layer functions at the lower layer 2152. In accordance with various aspects of this disclosure, a semantic controller 2154 may use input data from the lower layer 2152 that is lower than the application layer 2151 according to a communication reference model (e.g. OSI). In various examples, the lower layer 2152 may include a Network Access layer, Medium Access Control (MAC) layer, or physical (PHY) layer, and in particular, a lower PHY layer.

The semantic controller 2154 may operate at the lower layer 2152 or at a layer between the lower layer 2152 and the application layer 2151. In various examples, the semantic controller 2154 may also operate at the application layer 2151. Accordingly, the semantic controller 2154 may receive input data (e.g. intermediate data and metadata) using lower layer functions, or from lower layer functions provided at the lower layer 2152 by cross-layer information. Furthermore, the semantic controller 2154 may also receive scheduling information from a semantic scheduler of a transmitting entity. Although it may also be possible to receive the scheduling information from the lower layer 2152 as the received data, and the semantic channel may include a logical channel establishing a link between different layers of the protocol stack, the semantic controller 2154 may receive the scheduling information over a physical semantic channel that is different from the communication channel that the receiving entity 2150 receives the intermediate data and the metadata.

The receiving entity 2150 may also include a second portion of a distributed AI/ML module 2153 (from now on referred to as the AI/ML module 2153) that may receive input data including the intermediate data from the semantic controller 2154. The AI/ML module 2153 may also operate at the same layer with the semantic controller, at a layer between the lower layer 2152 and the application layer, or at the application layer 2152. Accordingly, in various examples that processors may implement the AI/ML module 2153 as provided in this disclosure, the AI/ML module 2153 may receive input from the semantic controller 2154 either according to layer functions of the respective layer that the semantic controller 2154 and the AI/ML module 2153 may operate or via cross-layer information. The AI/ML module 2153 may provide the outputs to the application layer 2151 using the application layer functions, or to the application layer functions via cross-layer information.

Furthermore, the receiving entity 2150 may also include a training agent 2155 that may receive input data including one or more communication medium parameters from the semantic controller 2154. In various examples, the training agent 2155 may also receive the input data from the lower layer 2152. The training agent 2155 may also operate at the same layer with the semantic controller 2154, at a layer between the lower layer 2152 and the application layer, or at the application layer 2152. Accordingly, the training agent 2155 may receive input from the semantic controller 2154 either according to layer functions of the respective layer that the semantic controller 2154 and the training agent 2155 may operate or via cross-layer information (from the lower layer 2152 or from the semantic controller 2154). The training agent 2155 may provide training data to the AI/ML module 2153 in a similar manner either using the respective layer functions, or via cross-layer information.

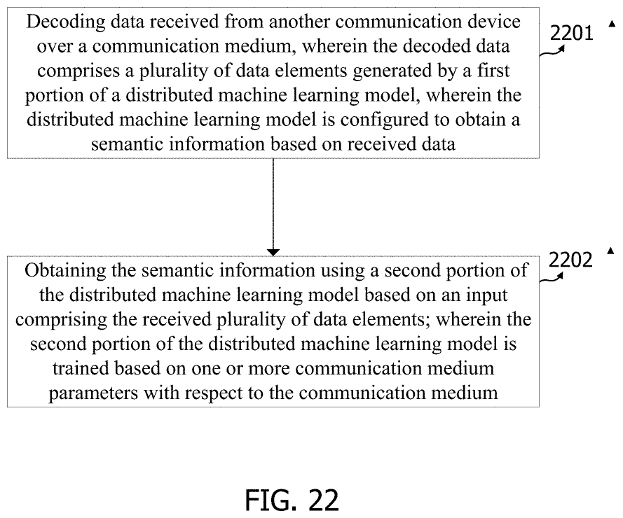

FIG. 22 shows an example of a method. The method may include decoding 2201 data received from another communication device over a communication medium, wherein the decoded data comprises a plurality of data elements generated by a first portion of a distributed machine learning model, wherein the distributed machine learning model is configured to obtain a semantic information based on received data, and obtaining 2202 the semantic information using a second portion of the distributed machine learning model based on an input comprising the received plurality of data elements; wherein the second portion of the distributed machine learning model is trained based on one or more communication medium parameters with respect to the communication medium.

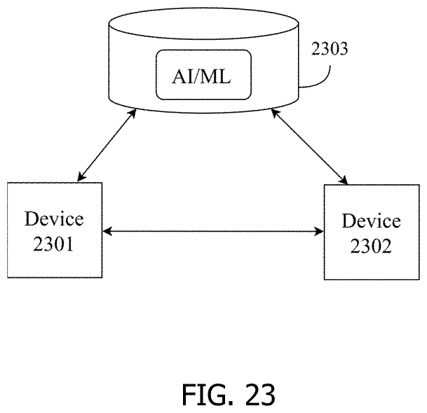

FIG. 23 exemplarily shows an illustration of a communication system. A first device 2301 (e.g. a transmitting entity) according various aspects as provided in this disclosure may communicate with a second device 2302 (e.g. a receiving entity) according to various aspects as provided in this disclosure. The first device 2301 and/or the second device 2302 are further communicatively coupled to a computing device (e.g. a cloud computing device) 2303 that implements the AI/ML as provided in this disclosure. Accordingly, the respective processors of the first device 2301 and/or the second device 2302 may provide the input to the computing device 2303 to obtain the output of the AI/ML.

The following examples pertain to further aspects of this disclosure.

In example 1, A device may include: a processor configured to: extract semantic information from received data; generate one or more data elements based on the extracted semantic information for an instance of time; generate metadata associated with the generated one or more data elements; schedule a transmission of the one or more data elements and the metadata according to a scheduling configuration; encode a scheduling information indicating the scheduling configuration for the transmission.

In example 2, the subject matter of example 1, can optionally include that the semantic information includes information representing one or more attributes detected from the received data. In example 3, the subject matter of example 2, can optionally include that the processor is configured to selectively apply a first encoding configuration and a second encoding configuration to the one or more data elements based on the extracted semantic information. In example 4, the subject matter of example 2 or example 3, can optionally include that each encoding configuration includes a predefined modulation coding scheme or a predefined transmit power configuration. In example 5, the subject matter of any one of examples 1 to 4, can optionally include that the processor is configured to selectively schedule the transmission of the metadata.

In example 6, the subject matter of any one of examples 1 to 5, can optionally include that the metadata further includes at least one of syntactic information of the received data, or structural information of the received data. In example 7, the subject matter of any one of examples 1 to 6, can optionally include that the processor is configured to schedule the transmission of the metadata and the one or more data elements independently from each other based on a network quality parameter. In example 8, the subject matter of any one of examples 1 to 7, can optionally include that the processor is configured to schedule the transmission of the metadata in intervals.

In example 9, the subject matter of any one of examples 1 to 8, can optionally include that the processor is configured to schedule the transmission of the one or more data elements more frequently than the transmission of the metadata. In example 10, the subject matter of any one of examples 1 to 9, can optionally include that the processor is configured to prioritize the transmission of the one or more data elements relative to the transmission of the metadata based on the network quality parameter. In example 11, the subject matter of any one of examples 1 to 10, can optionally include that the metadata includes context information of the received data. In example 12, the subject matter of any one of examples 1 to 11, can optionally include that the processor is configured to schedule a transmission of the received data.

In example 13, the subject matter of any one of examples 1 to 12, can optionally include that the processor is configured to selectively schedule the transmission of the data or the transmission of the one or more data elements. In example 14, the subject matter of any one of examples 1 to 13, can optionally include that the processor is configured to determine at least one of a protection level or a priority level for the one or more data elements. In example 15, the subject matter of any one of examples 1 to 14, can optionally include that the processor is configured to determine at least one of a protection level or a priority level for the data elements of the metadata. In example 16, the subject matter of any one of examples 1 to 15, can optionally include that the one or more data elements and the metadata includes information of a plurality of instances of time.

In example 17, the subject matter of any one of examples 1 to 16, can optionally include that the processor is configured to extract the semantic information using a machine learning model configured to receive an input may include the received data and provide an output may include the extracted semantic information. In example 18, the subject matter of any one of examples 1 to 17, can optionally include that the extracted semantic information includes an intermediate information which requires further processing to obtain an information representing one or more detected attributes of the received data.

In example 19, the subject matter of any one of examples 1 to 18, can optionally include that the machine learning model is further configured to provide the output may include the metadata. In example 20, the subject matter of any one of examples 1 to 19, can optionally include that the machine learning model is further configured to provide the output may include a protection level or a priority level for the extracted semantic information. In example 21, the subject matter of any one of examples 1 to 20, can optionally include that the processor is configured to: provide application layer functions implemented at application layer according to a communication reference model; provide network access layer functions implemented at a lower layer that is lower than the application layer according to the communication reference model; can optionally include that the machine learning model is configured to receive the input from the application layer functions; can optionally include that the processor is configured to provide scheduling information to schedule the transmissions to the network access layer functions.

In example 22, the subject matter of example 21, can optionally include that the network access layer functions include a medium access control (MAC) layer function or a physical (PHY) layer function. In example 23, the subject matter of example 21 or example 22, can optionally include that the machine learning model is configured to receive a cross-layer information may include at least a portion of the input from the application layer functions. In example 24, the subject matter of any one of examples 21 to 24, can optionally include that the machine learning model is configured to provide a cross-layer information may include the scheduling information to schedule the transmissions to the lower layer functions.

In example 25, the subject matter of any one of examples 1 to 24, can optionally include that the scheduling information includes information indicating the schedule of the transmissions. In example 26, the subject matter of any one of examples 1 to 25, can optionally include that the one or more data elements and the metadata are scheduled for a transmission over a physical channel; can optionally include that the encoded scheduling information is scheduled for a transmission over a semantic channel. In example 27, the subject matter of any one of examples 1 to 26, can optionally include that the received data includes one or more images; can optionally include that the one or more data elements includes information indicating at least one of detected objects, background, or kinematic attributes of the detected objects; can optionally include that the metadata includes information indicating at least one of weather condition, lighting, or color of the detected objects.

In example 28, the subject matter of any one of examples 1 to 27, can optionally include that the received data includes speech data; can optionally include that the one or more data elements includes information indicating one or more words; can optionally include that the metadata includes information indicating at least one of detected emotion, words per minute, or pauses between the words.

In example 29, a method may include: extracting semantic information from received data; generating one or more data elements based on the extracted semantic information for an instance of time; generating metadata associated with the generated one or more data elements; scheduling a transmission of the one or more data elements and the metadata according to a scheduling configuration; encoding scheduling information indicating the scheduling configuration for a transmission.

In example 30, a non-transitory computer-readable medium may include one or more instructions which, if executed by a processor, cause the processor to: extract semantic information from received data; generate one or more data elements based on the extracted semantic information for an instance of time; generate metadata associated with the generated one or more data elements; schedule a transmission of the one or more data elements and the metadata according to a scheduling configuration; encode scheduling information indicating the scheduling configuration for a transmission.

In example 31, the subject matter includes a device including: a processor configured to: decode received data to obtain a scheduling configuration, a plurality of data elements and metadata; obtain semantic data for an instance of time may include one or more data elements of the plurality of data elements based on the scheduling configuration and the plurality of data elements; obtain semantic information based on the semantic data and the metadata.

In example 32, the subject matter of example 31, can optionally include that the obtained semantic information indicates one or more detected attributes. In example 33, the subject matter of example 32, can optionally include that the processor is configured to decode first received data based on a first decoding configuration to obtain some of the plurality of data elements; can optionally include that the processor is configured to decode second received data based on a second decoding configuration to obtain some of the remaining plurality of data elements. In example 34, the subject matter of example 33, can optionally include that each decoding configuration includes a predefined modulation coding scheme or a predefined transmit power configuration.

In example 35, the subject matter of example 34, can optionally include that the scheduling configuration includes information indicating a decoding configuration. In example 36, the subject matter of any one of examples 31 to 35, can optionally include that the metadata further includes at least one of syntactic information or structural information associated with the semantic data. In example 37, the subject matter of any one of examples 31 to 36, can optionally include that the processor is configured to decode received raw data; can optionally include that the scheduling configuration includes information indicating a scheduled transmission of the received raw data.

In example 38, the subject matter of any one of examples 31 to 37, can optionally include that the one or more data elements of the semantic data includes information indicating a priority level or a protection level. In example 39, the subject matter of any one of examples 31 to 38, can optionally include that the semantic data and the metadata includes information of a plurality of instances of time. In example 40, the subject matter of any one of examples 31 to 39, can optionally include that the one or more data elements of the semantic data include information indicating a detected attribute in a time-series configuration; can optionally include that the processor is further configured to detect an anomaly at the one or more data elements of the semantic data.

In example 41, the subject matter of example 40, can optionally include that the processor is configured to correct the anomaly based on the detected attribute in the time-series configuration. In example 42, the subject matter of any one of examples 31 to 41, can optionally include that the processor is configured to implement a machine learning model configured to receive an input may include the semantic data and the metadata and provide an output may include one or more inferred attributes based on the semantic data. In example 43, the subject matter of any one of examples 31 to 42, can optionally include that the processor is configured to implement a trained machine learning model configured to receive an input may include the semantic data and the metadata and provide an output attribute information representing a detected attribute.

In example 44, the subject matter of any one of examples 42 or 43, can optionally include that the machine learning model includes a trained machine learning model, can optionally include that the machine learning model is trained based on one or more communication medium parameters with respect to a communication medium that the device receives the received data. In example 45, the subject matter of example 44, can optionally include that the trained machine learning model is trained with a supervised training. In example 46, the subject matter of example 45, can optionally include that the input of the trained machine learning model includes the semantic data and the one or more communication medium parameters.

In example 47, the subject matter of any one of examples 42 to 46, further may include: a memory configured to store the machine learning model parameters and a training data. In example 48, the subject matter of example 47, can optionally include that the processor is configured to adjust the training data based on one or more predefined communication medium parameters; can optionally include that the processor is configured to provide the adjusted training data to the machine learning model. In example 49, the subject matter of any one of examples 44 to 48, can optionally include that the processor is configured to determine the predefined one or more communication medium parameters based on a network simulation.

In example 50, the subject matter of any one of examples 44 to 49, can optionally include that the processor is configured to estimate the one or more communication medium parameters based on one or more measurements for the communication medium. In example 51, the subject matter of example 50, can optionally include that the communication medium includes a radio communication channel; can optionally include that the processor is configured to estimate the one or more communication medium parameters by a channel estimation for the radio communication channel. In example 52, the subject matter of any one of examples 47 to 51, can optionally include that the processor is configured to train the machine learning model by providing the one or more communication parameters and the training data to the input of the machine learning model.

In example 53, the subject matter of any one of examples 47 to 52, can optionally include that the processor is configured to adjust the machine learning model parameters based on the output of machine learning model and a supervising input. In example 54, the subject matter of any one of examples 42 to 53, can optionally include that the processor is configured to: provide application layer functions implemented at application layer according to a communication reference model; provide network access layer functions implemented at a layer lower than the application layer according to the communication reference model; can optionally include that the machine learning model is configured to receive the input from the lower layer functions; can optionally include that the processor is configured to provide the one or more inferred attributes to the application layer functions.

In example 55, the subject matter of example 54, can optionally include that the lower layer functions include medium access control (MAC) layer functions or physical (PHY) layer functions. In example 56, the subject matter of example 54 or example 55, can optionally include that the machine learning model is configured to receive a cross-layer information may include the input from the lower layer functions. In example 57, the subject matter of any one of examples 54 to 56, can optionally include that the machine learning model is configured to provide a cross-layer information may include the one or more inferred attributes to the application layer functions.

In example 58, the subject matter of any one of examples 31 to 57, can optionally include that the scheduling configuration is received from a semantic channel and the received data is received from a physical channel.

In example 59, a method may include: decoding received data to obtain a scheduling configuration, a plurality of data elements and metadata; obtaining semantic data may include one or more data elements of the plurality of data elements based on the scheduling configuration and the plurality of data elements; obtaining semantic information for an instance of time based on the semantic data and the metadata.

In example 60, a non-transitory computer-readable medium may include one or more instructions, which, if executed by a processor, cause the processor to: decode received data to obtain a scheduling configuration, a plurality of data elements and metadata; obtain semantic data may include one or more data elements of the plurality of data elements based on the scheduling configuration and the plurality of data elements; obtain semantic information for an instance of time based on the semantic data and the metadata.

In example 61, the subject matter includes a device that may include: a processor configured to: decode data received from another communication device over a communication medium, can optionally include that the decoded data includes a plurality of data elements generated by a first portion of a distributed machine learning model, can optionally include that the distributed machine learning model is configured to obtain semantic information based on received data, obtain the semantic information using a second portion of the distributed machine learning model based on an input may include the received plurality of data elements, can optionally include that the second portion of the distributed machine learning model is trained based on one or more communication medium parameters with respect to the communication medium.

In example 62, the subject matter of example 61, can optionally include that the second portion of the distributed machine learning model is trained with a supervised training. In example 63, the subject matter of example 61 or example 62, further may include a memory configured to store the machine learning model parameters and training data. In example 64, the subject matter of example 63, can optionally include that the processor is configured to adjust the training data based on one or more predefined communication medium parameters; can optionally include that the processor is configured to provide the adjusted training data to the second portion of the distributed machine learning model.

In example 65, the subject matter of example 64, can optionally include that the processor is configured to determine the one or more predefined communication medium parameters based on a network simulation. In example 66, the subject matter of any one of examples 63 to 65, can optionally include that the processor is configured to estimate the one or more communication medium parameters based on one or more measurements for the communication medium; can optionally include that the communication medium includes a radio communication channel; can optionally include that the processor is configured to estimate the one or more communication medium parameters by a channel estimation for the radio communication channel.

In example 67, the subject matter of any one of examples 63 to 66, can optionally include that the second portion of the distributed machine learning model is configured to receive the one or more communication medium parameters. In example 68, the subject matter of any one of examples 63 to 67, can optionally include that the second portion of the distributed machine learning model is configured to determine the semantic information based on the input may include the plurality of data elements and the one or more communication medium parameters. In example 69, the subject matter of any one of examples 67 or 68, can optionally include that the processor is configured to train the second portion of the distributed machine learning model by providing the one or more communication parameters and the training data to the input of the second portion of the distributed machine learning model.

In example 70, the subject matter of any one of examples 63 to 69, can optionally include that the processor is configured to adjust the machine learning model parameters based on the output of the second portion of the distributed machine learning model and a supervising input. In example 71, the subject matter of any one of examples 61 to 70, can optionally include that the processor is configured to: provide application layer functions implemented at an application layer according to a communication reference model; provide network access layer functions implemented at a layer lower than the application layer according to the communication reference model; can optionally include that the machine learning model is configured to receive the input from the lower layer functions; can optionally include that the machine learning model is configured to provide the one or more inferred attributes to the application layer functions. In example 72, the subject matter of example 71, can optionally include that the lower layer functions include medium access control (MAC) layer functions or physical (PHY) layer functions.

In example 73, the subject matter of example 71 or example 72, can optionally include that the machine learning model is configured to receive a cross-layer information may include the input from the lower layer functions. In example 74, the subject matter of any one of examples 71 to 73, can optionally include that the machine learning model is configured to provide a cross-layer information may include the one or more inferred attributes to the application layer functions. In example 75, the subject matter of any one of examples 61 to 74, can optionally include that the scheduling configuration is received from a semantic channel and the received data is received from a physical channel.

In example 76, A system may include: a receiving device may include the device of any one of examples 61 to 74; a transmitting device may include: an input interface configured to receive data. a processor configured to: implement the first portion of the distributed machine learning model, can optionally include that the first portion of the distributed machine learning model is configured to receive an input may include the data and provide an output may include the plurality of data elements; encode the plurality of data elements for a transmission over the communication medium.

In example 77, a method may include: decoding data received from another communication device over a communication medium, can optionally include that the decoded data includes a plurality of data elements generated by a first portion of a distributed machine learning model, can optionally include that the distributed machine learning model is configured to obtain a semantic information based on received data, obtaining the semantic information using a second portion of the distributed machine learning model based on an input may include the received plurality of data elements; can optionally include that the second portion of the distributed machine learning model is trained based on one or more communication medium parameters with respect to the communication medium.

In example 78, a non-transitory computer-readable medium may include one or more instructions which, if executed by a processor, cause the processor to: decode data received from another communication device over a communication medium, can optionally include that the decoded data includes a plurality of data elements generated by a first portion of a distributed machine learning model, can optionally include that the distributed machine learning model is configured to obtain semantic information based on received data, obtain the semantic information using a second portion of the distributed machine learning model based on an input may include the received plurality of data elements; can optionally include that the second portion of the distributed machine learning model is trained based on one or more communication medium parameters with respect to the communication medium.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal that is “indicative of” or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor or 9. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more.”

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D Points, among others, or any combination thereof. Registers, shift registers, processor registers, data buffers, among others, are also embraced herein by the term memory. The term “software” refers to any type of executable instruction, including firmware.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

The term “antenna”, as used herein, may include any suitable configuration, structure and/or arrangement of one or more antenna elements, components, units, assemblies and/or arrays. The antenna may implement transmit and receive functionalities using separate transmit and receive antenna elements. The antenna may implement transmit and receive functionalities using common and/or integrated transmit/receive elements. The antenna may include, for example, a phased array antenna, a single element antenna, a set of switched beam antennas, and/or the like.

It will be understood that when an element is referred to as being “connected” or “coupled” to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), Time-Division Multiplexing (TDM), Time-Division Multiple Access (TDMA), Multi-User MIMO (MU-MIMO), General Packet Radio Service (GPRS), extended GPRS (EGPRS), Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (BT), Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other aspects may be used in various other devices, systems and/or networks.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN, and the like.

Some aspects may be used in conjunction with a wireless communication network communicating over a frequency band of 2.4 GHz, 5 GHz, and/or 6-7 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A device comprising:
a processor configured to:
extract semantic information from received data;
generate one or more data elements based on the extracted semantic information for an instance of time;
generate metadata associated with the generated one or more data elements;
schedule a transmission of the one or more data elements and the metadata according to a scheduling configuration;
encode a scheduling information indicating the scheduling configuration for the transmission.

2. The device of claim 1,
wherein the processor is configured to selectively apply a first encoding configuration and a second encoding configuration to the one or more data elements based on the extracted semantic information;
wherein each encoding configuration comprises a predefined modulation coding scheme or a predefined transmit power configuration.

3. The device of claim 1,
wherein the processor is configured to schedule the transmission of the metadata and the one or more data elements independently from each other based on a network quality parameter.

4. The device of claim 3,
wherein the processor is configured to schedule the transmission of the metadata in intervals;
wherein the processor is configured to schedule the transmission of the one or more data elements more frequently than the transmission of the metadata.

5. The device of claim 3,
wherein the processor is configured to prioritize the transmission of the one or more data elements relative to the transmission of the metadata based on the network quality parameter.

6. The device of claim 1,
wherein the processor is configured to schedule a transmission of the received data;
wherein the processor is configured to selectively schedule the transmission of the received data or the transmission of the one or more data elements.

7. The device of claim 1,
wherein the processor is configured to determine at least one of a protection level or a priority level for the one or more data elements;
wherein the processor is configured to determine at least one of a protection level or a priority level for the data elements of the metadata.

8. The device of claim 1,
wherein the processor is configured to extract the semantic information using a machine learning model configured to receive an input comprising the received data and provide an output comprising the extracted semantic information;
wherein the machine learning model is further configured to provide the output comprising the metadata;
wherein the machine learning model is further configured to provide the output comprising a protection level or a priority level for the extracted semantic information.

9. The device of claim 8,
wherein the processor is configured to:
provide application layer functions implemented at application layer according to a communication reference model;
provide network access layer functions implemented at a lower layer that is lower than the application layer according to the communication reference model;
wherein the machine learning model is configured to receive the input from the application layer functions;
wherein the processor is configured to provide scheduling information to schedule the transmissions to the network access layer functions;
wherein the machine learning model is configured to receive a cross-layer information comprising at least a portion of the input from the application layer functions;
wherein the machine learning model is configured to provide a cross-layer information comprising the scheduling information to schedule the transmissions to the lower layer functions.

10. A device comprising:
a processor configured to:
decode received data to obtain a scheduling configuration, a plurality of data elements and metadata;
obtain semantic data for an instance of time comprising one or more data elements of the plurality of data elements based on the scheduling configuration and the plurality of data elements;
obtain semantic information based on the semantic data and the metadata.

11. The device of claim 10,
wherein the obtained semantic information indicates one or more detected attributes;
wherein the processor is configured to decode first received data based on a first decoding configuration to obtain some of the plurality of data elements;
wherein the processor is configured to decode second received data based on a second decoding configuration to obtain some of the remaining plurality of data elements.

12. The device of claim 10,
wherein the one or more data elements of the semantic data comprise information indicating a detected attribute in a time-series configuration;
wherein the processor is further configured to detect an anomaly at the one or more data elements of the semantic data;
wherein the processor is configured to correct the anomaly based on the detected attribute in the time-series configuration.

13. The device of claim 10,
wherein the processor is configured to implement a machine learning model configured to receive an input comprising the semantic data and the metadata and provide an output comprising one or more inferred attributes based on the semantic data.

14. The device of claim 13,
wherein the machine learning model comprises a trained machine learning model, wherein the machine learning model is trained based on one or more communication medium parameters with respect to a communication medium that the device receives the received data.

15. The device of claim 14,
wherein the input of the trained machine learning model comprises the semantic data and the one or more communication medium parameters.

16. The device of claim 13,
wherein the processor is configured to:
provide application layer functions implemented at application layer according to a communication reference model;
provide network access layer functions implemented at a layer lower than the application layer according to the communication reference model;
wherein the machine learning model is configured to receive the input from the lower layer functions;
wherein the processor is configured to provide the one or more inferred attributes to the application layer functions.

17. The device of claim 16,
wherein the lower layer functions comprise medium access control (MAC) layer functions or physical (PHY) layer functions;
wherein the machine learning model is configured to receive a cross-layer information comprising the input from the lower layer functions;
wherein the machine learning model is configured to provide a cross-layer information comprising the one or more inferred attributes to the application layer functions.

18. The device of claim 17
wherein the scheduling configuration is received from a semantic channel and the received data is received from a physical channel.

19. A device comprising:
a processor configured to:
decode data received from another communication device over a communication medium, wherein the decoded data comprises a plurality of data elements generated by a first portion of a distributed machine learning model, wherein the distributed machine learning model is configured to obtain semantic information based on received data,
obtain the semantic information using a second portion of the distributed machine learning model based on an input comprising the received plurality of data elements, wherein the second portion of the distributed machine learning model is trained based on one or more communication medium parameters with respect to the communication medium.

20. The device of claim 19,
further comprising a memory configured to store the machine learning model parameters and training data;
wherein the processor is configured to adjust the training data based on one or more predefined communication medium parameters;
wherein the processor is configured to provide the adjusted training data to the second portion of the distributed machine learning model.

21. The device of claim 20,
wherein the second portion of the distributed machine learning model is configured to receive the one or more communication medium parameters.

22. The device of claim 21,
wherein the second portion of the distributed machine learning model is configured to determine the semantic information based on the input comprising the plurality of data elements and the one or more communication medium parameters.

23. The device of claim 22,
wherein the processor is configured to train the second portion of the distributed machine learning model by providing the one or more communication parameters and the training data to the input of the second portion of the distributed machine learning model.

24. The device of claim 23,
wherein the processor is configured to:
provide application layer functions implemented at an application layer according to a communication reference model;
provide network access layer functions implemented at a layer lower than the application layer according to the communication reference model;
wherein the machine learning model is configured to receive the input from the lower layer functions;
wherein the machine learning model is configured to provide the one or more inferred attributes to the application layer functions.

25. The device of claim 24,
wherein the lower layer functions comprise medium access control (MAC) layer functions or physical (PHY) layer functions;
wherein the machine learning model is configured to receive a cross-layer information comprising the input from the lower layer functions;
wherein the machine learning model is configured to operate at a semantic layer.
